(19) United States
(12) Patent Application Publication
(10) Pub. No.: US 2026/0187459 A1
(43) Pub. Date: Jul. 2, 2026

(54) LANGUAGE MODEL FOR JOINT REPRESENTATION OF CONTENT AND ACTIVITIES

(71) Applicant: Microsoft Technology Licensing, LLC, Redmond, WA (US)

(72) Inventors: Benjamin Hoan Le, Santa Clara, CA (US); Nikita Gennadievich Zhiltsov, San Jose, CA (US); Timothy James Hazen, Arlington, MA (US); Yu Jiang, Los Altos, CA (US); Xiao Shi, Sunnyvale, CA (US); Rajat Arora, Sunnyvale, CA (US)

(21) Appl. No.: 19/005,769

(22) Filed: Dec. 30, 2024

(51) Int. Cl. G06N 3/084; G06N 3/0455

(52) U.S. Cl. CPC G06N 3/084; G06N 3/0455

(57) ABSTRACT

Model input is formulated for a language model having a first encoder tower, a second encoder tower, and a fusion sub-model. The model input includes a natural language representation of activities including first digital content, and second digital content. The natural language representation of activities is provided to an input layer of the first encoder tower. The second digital content is provided to an input layer of the second encoder tower. An output layer of the first encoder tower produces a machine learning-based representation of the activities. An output layer of the second encoder tower produces a machine learning-based representation of the second digital content. The machine learning-based representations of the activities and the second digital content are provided to the fusion sub-model. The fusion sub-model produces a predicted outcome using the machine learning-based representations of the activities and the second digital content.

### TECHNICAL FIELD

A technical field to which this disclosure relates is representation learning.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

Matching systems are computer systems that generate predictive output indicating the extent to which digital items are similar to each other according to one or more criteria. Ranking systems rank digital items in accordance with one or more ranking criteria, which may be different from the criteria used to determine similarity. Recommendation systems often include a matching component and a ranking component, where the matching component identifies digital items that are candidates for recommendations and the ranking component ranks the identified digital items for different recommendation tasks such that the rank of an item may determine whether, when, and how frequently the item is included in recommendations.

### BRIEF DESCRIPTION OF THE DRAWINGS

The disclosure will be understood more fully from the detailed description given below and from the accompanying drawings of various examples of the disclosure. The drawings are for explanation and understanding only and should not be taken to limit the disclosure to the specific examples shown.

FIG. 1 is a component-based flow diagram of an example method for generating recommendations using machine learning-based content and activity representations produced by a language model in accordance with some examples of the present disclosure.

FIG. 2 is a component-based flow diagram of an example method for training a language model to jointly learn content and activity representations in accordance with some examples of the present disclosure.

FIG. 3 is a component-based flow diagram of an example method for predicting an outcome using machine learning-based content and activity representations generated by a language model in accordance with some examples of the present disclosure.

FIG. 4 is a component-based flow diagram of an example method for designing, building, storing, and using a language model with multiple encoder towers in accordance with some examples of the present disclosure.

FIG. 5 is a block diagram of an example encoder neural network in accordance with some examples of the present disclosure.

FIG. 6 is a flow diagram of an example method for representation learning using a language model in accordance with some examples of the present disclosure.

FIG. 7 is a block diagram of a computing system that includes a representation learning system in accordance with some examples of the present disclosure.

FIG. 8 is a block diagram of an example computer system including components of a representation learning system in accordance with some examples of the present disclosure.

### DETAILED DESCRIPTION

In computer science, an artificial neural network, or simply neural network, is a type of machine learning model. A neural network includes functional units, also referred to as nodes, connected by edges. Groups of units are arranged into layers. Units receive input signals from connected units, process the input signals using activation functions, and provide output signals to other connected units. The output of each unit is computed by the activation function. The connections between the units apply weight values to the signals. These weight values are adjusted through a training process. Different layers of the neural network may perform different transformations on the respective inputs and pass output of the respective transformations to other layers.

A technical challenge is how to configure machine learning models to efficiently and reliably interpret raw input such as natural language words in text and pixels in images. Representation learning refers to processes that use machine learning to transform raw data into patterns or “representations” of the raw data, such that the resulting representations are capable of being interpreted by machine learning models to perform prediction, classification, and/or other tasks in useful and reliable way. Representations are sometimes referred to as embeddings or vectors, which are numerical representations of raw data created by a neural network machine learning model. A numerical representation represents raw data as numerical values so that similar items of raw data have similar numerical representations.

A related technical challenge is how to jointly learn and generate machine learning-based representations of digital content and sequences of digital activities using a single machine learning model. This technical challenge arises from the fact that content and activity sequences have been historically treated as different types of data that need to be modeled differently. As a result, in other approaches, representation learning for content and related activities has been divided into disjoint sequential tasks. In those approaches, content representation learning is performed firstly using neural networks to produce a single representation of a content item based solely on the content itself. The content representation is then used as input to the activity representation learning process. To generate the activity representation, sequential modeling is used to, for example, apply recurrent neural networks to a stream of content and activity pairs. Sequential modeling is time consuming and introduces operational complexity because two separate representation learning systems need to be maintained. Also, in practice, the resulting activity representations have been sub-optimal, likely due to the separation of the content and activity learning tasks.

As described in more detail with reference to the figures, a technical solution to the above and/or other technical challenges is to construct a single machine learning model that is capable of jointly learning representations of both content and activities, rather than learning those representations sequentially using two separate models. The described model architecture includes a transformer-based language model that supports long context windows in the input. Context window refers to a length (e.g., number of tokens) or size (e.g., number of bytes) of input that a language model is capable of processing during a given task. A long context window refers to a context window that has a length or size that exceeds a threshold. In some examples, the threshold corresponds to a minimum context window length or size needed to support the expected lengths or sizes of activity input for a given application. The threshold value is variable depending on the types or characteristics of the activities, the requirements of the particular application, and/or the specifications of the language model. In some examples, the threshold value is greater than or equal to 100,000 tokens or 32k bytes.

The described language model has multiple encoder towers that are arranged to generate machine learning-based representations (e.g., embeddings, vector representations, etc.) of different types of input, including both digital content and digital activities. The output of the encoder towers are coupled with a fusion layer. The output of the fusion layer is used to generate predictions. Thus, instead of using two different, separate, machine learning models to sequentially generate content and activity representations, respectively, and then potentially a third model to generate predictions, a single model as described is capable of both jointly learning content and activity embeddings and generating predictions for one or multiple different prediction types or objectives. The number of towers in the multi-tower architecture is adaptable based on engineering requirements or constraints, characteristics of the model input, desired prediction types, and/or other considerations.

Using the described approaches, operational efficiency of the representation learning system is improved by unifying content and activity representation learning via a single language model and using text as the common input modality. Benefits of the described approaches include simplification of the software stack and the ability to optimize task-specific predictive performance via joint fine tuning. In some examples, a single model is optimized for multiple different, specific tasks (or prediction types). In some examples, the described model is optimized for different types of predictions including the likelihood a user will apply for a job, given a description of the job posting and information about the user's online activity history related to job postings distributed online (“pApply”) and the likelihood a user will click on a content item (e.g., in a news feed), given a description of the content item and information about the user (“pCTR”), where previously, separate models needed to be optimized for each of these predictions. In some examples, the described model is optimized for up to five or more different prediction types including engagement-based signals like pApply and pCTR, as well as non-engagement-based signals such as qualification fit (relevance based on how well a user's online profile matches the qualifications of a job posting), interest fit (relevance based on how well a user's profile matches the description of a job posting), and context fit (how well does a query match a content item or job posting).

Deploying generative machine learning models in production presents significant technical challenges such as high computational costs, complex deployment pipelines, and the need for continuous adaptation to domain-specific and/or dynamically changing data. In some examples, the model architecture is capable of handling complex generative machine learning model deployments while maintaining acceptable latency for embedding generation at scale, e.g., for tens of millions of daily active users and content items on an online platform. In some examples, the model architecture is capable of generating and serving high quality embeddings for specific recommendation tasks, such as job recommendations, using fine-tuned generative machine learning models. In some examples, the model architecture has been shown to enhance predictive performance and reduce operational costs by removing the need to compute intermediate predicted features and instead provide for direct input understanding via fine-tuned language models.

The disclosure will be understood more fully from the detailed description given below, which references the accompanying drawings. The detailed description of the drawings is for explanation and understanding, and should not be taken to limit the disclosure to the specific examples described.

In the drawings and the following description, components shown and described in connection with an example are usable with or incorporated into other examples. In some examples, a component illustrated in a certain drawing is not limited to use in connection with an example to which the drawing pertains, but is usable with or incorporated into other examples, including examples shown in other drawings.

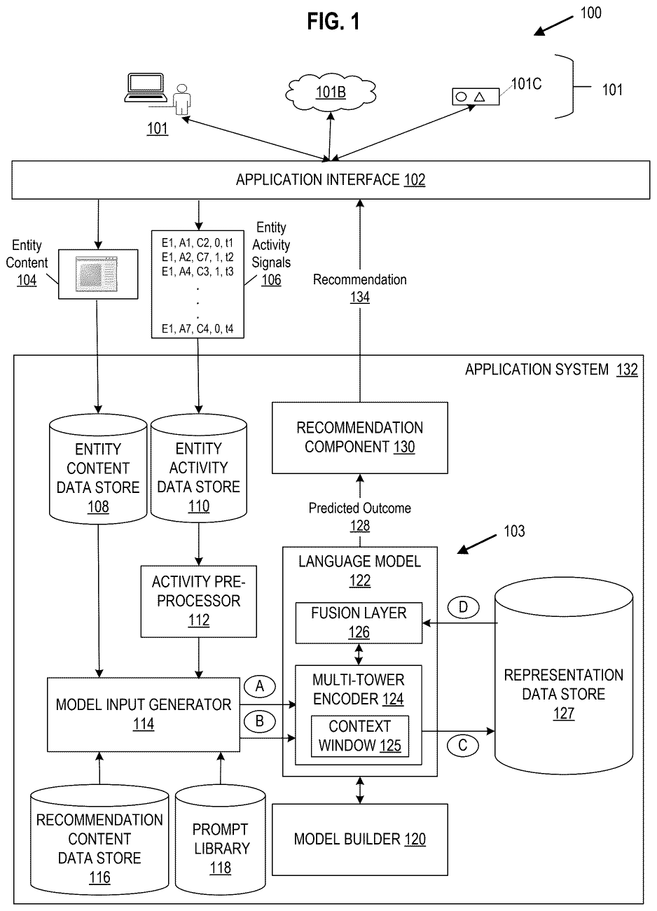

FIG. 1 is a component-based flow diagram of an example method for generating recommendations using machine learning-based content and activity representations produced by a language model in accordance with some examples of the present disclosure.

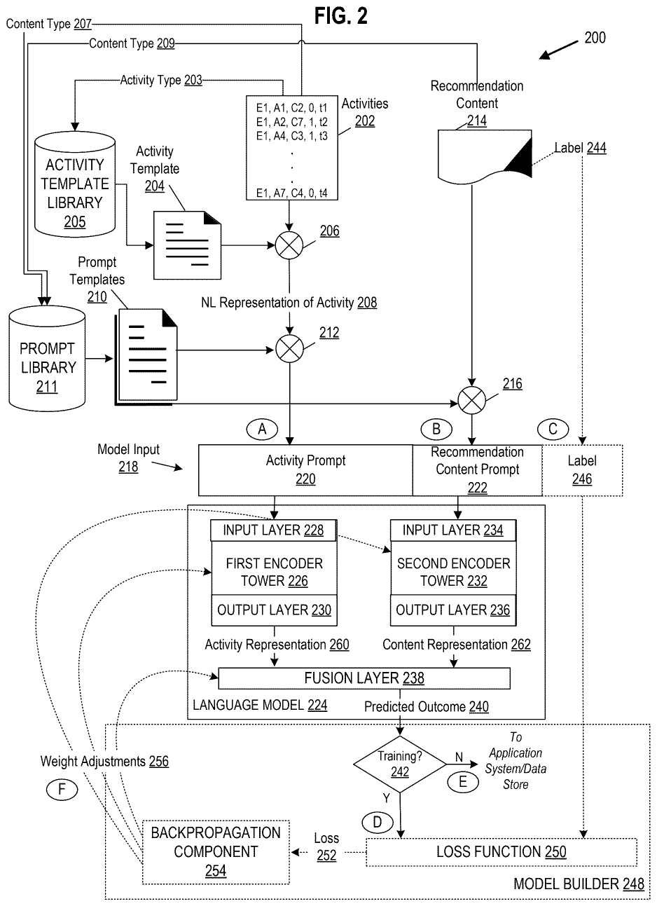

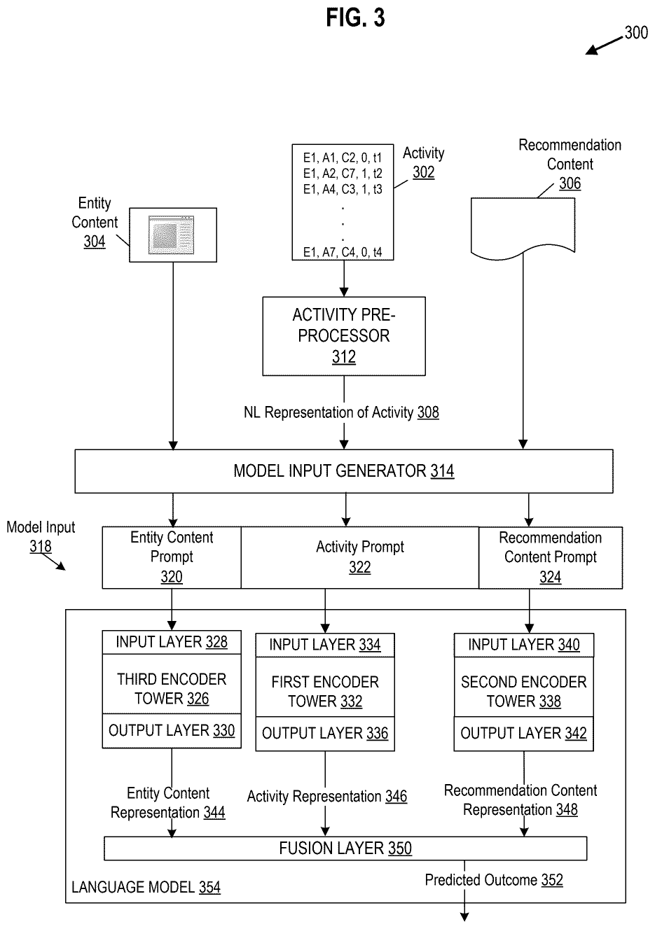

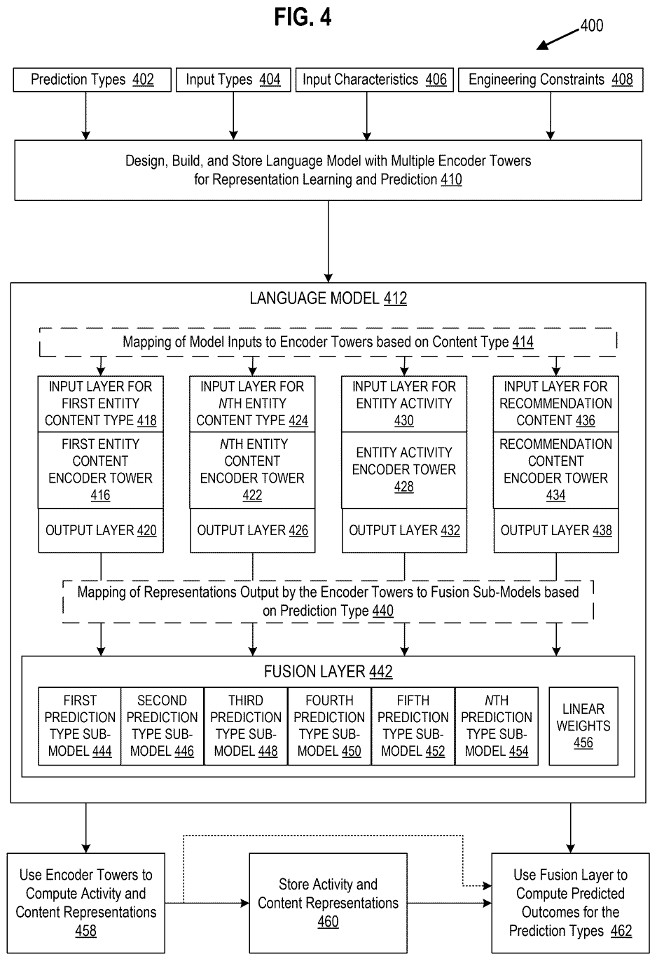

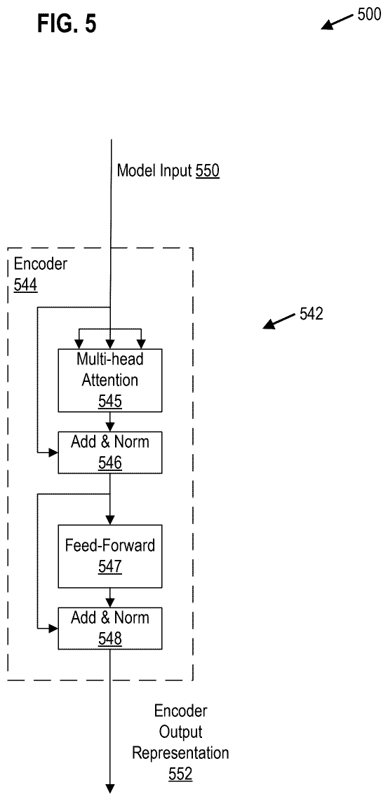

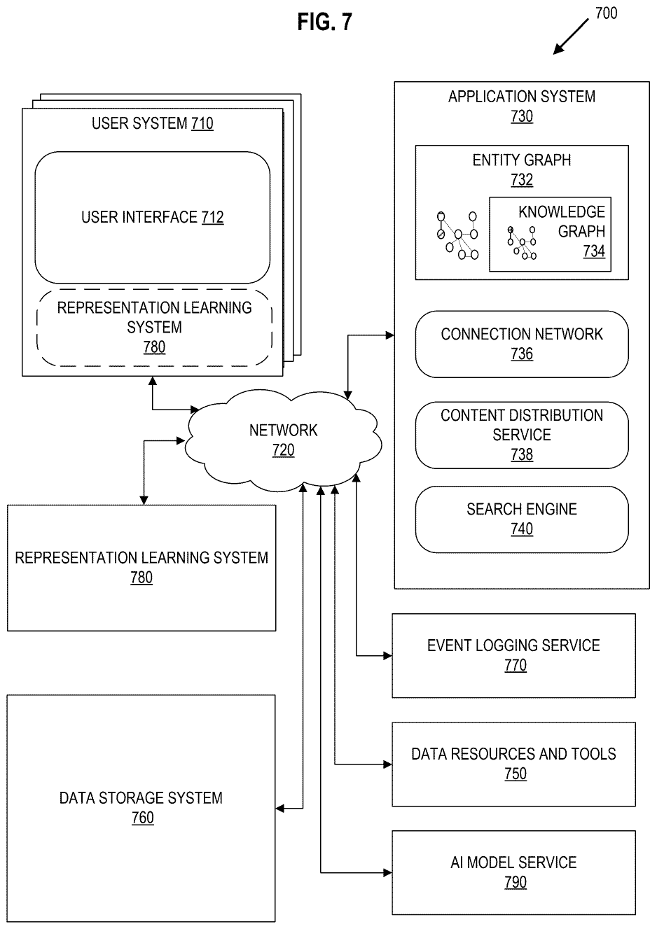

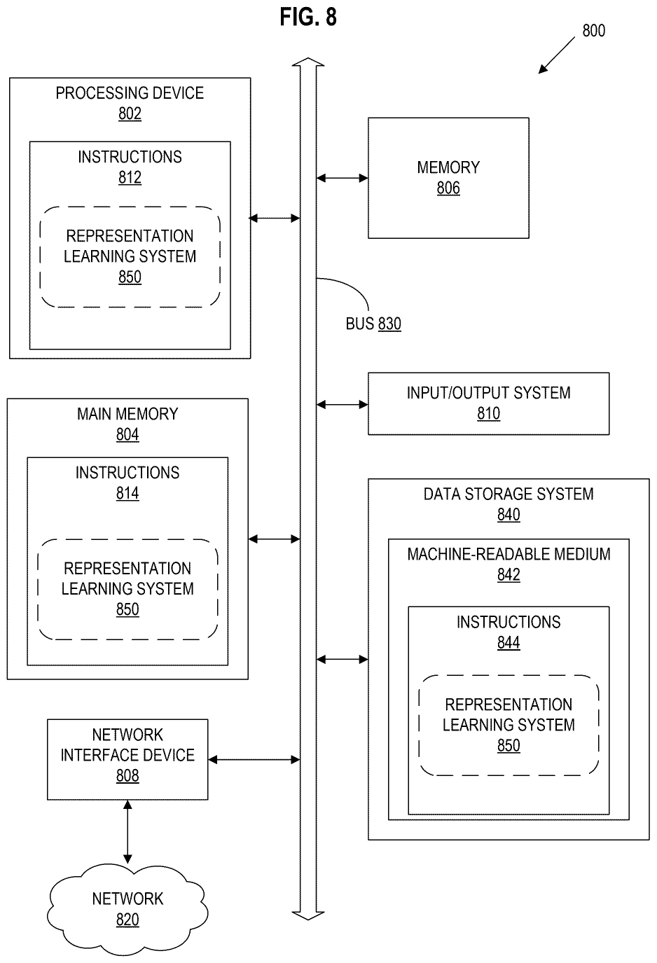

In FIG. 1, portions of a method 100 for generating and outputting recommendations based on content and activity representations are performed by various components of an application system 132. The method 100 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, portions of the method 100 are performed by one or more computing system components shown in FIG. 1, FIG. 2, FIG. 3, FIG. 4, FIG. 5, computing system 700 of FIG. 7, or computer system 800 of FIG. 8. Although shown in a particular sequence or order, unless otherwise specified, the order of the processes is modified in some examples. The processes are performed in a different order, and some processes are performed in parallel, in some examples. One or more processes are omitted in various examples. Not all processes are required in every example. Other process flows are possible.

In FIG. 1, the method 100 is represented by arrows connecting components of a computing system. The illustrated computing system includes an environment 101, an application interface 102, and an application system 132 that includes a representation learning system 103. The environment 101, application interface 102 and application system 132 are implemented using at least one computing device, such as an application server or server cluster, for the processing of electronic transmissions or signals, including transmissions of data and transmission of instructions. In some examples, the environment 101, application interface 102 and/or application system 132 includes a secure environment (e.g., secure enclave, encryption system, etc.). In some examples, portions of the application system 132 are implemented on a client device, such as a user system 710, described with reference to FIG. 7. In some examples, some or all of application system 132 is implemented directly on a user's device or within an embedded system, thereby avoiding the need to communicate with servers over a network such as the Internet.

In FIG. 1, the method 100 includes computer-implemented steps for receiving and processing entity content 104 and/or entity activity signals 106 and providing recommendations 134 to the application interface 102 via components of the application system 132 including the representation learning system 103.

The environment 101 includes one or more user devices 101A, a network 101B, and/or one or more sensing devices 101C. Examples of user devices 101A include computing devices, such as laptop computers, smart phones, mobile or portable computing devices, smart appliances, wearable devices, haptic controls, vehicle controls, robotic devices, semi-autonomous devices or autonomous devices, and other types of devices. Examples of networks 101B include wireless, optical, and wired communication networks. Examples of sensing devices 101C include motion sensors, load cells, force sensors, light sensors, angle sensors, accelerometers, gyroscopes, temperature sensors, physiological sensors, energy sensors, network sensors, and other types of sensing devices. Device refers to a hardware and/or software device. In some examples, device refers to an artificial intelligence-based agent, such as a semi-autonomous or autonomous agent of a user or other entity.

The application interface 102 includes an application layer, presentation layer, and/or data layer of the computing system. The application system 132 includes application system 730 described with reference to FIG. 7, a device control system, a network security application, or another type of application software system. The application interface 102 manages and facilitates electronic and/or electromagnetic communications (e.g., digital and/or analog signals) related to an entity between the environment 101 and the application system 132.

Examples of entities include computing system users, digital content items, such as posts, feed items, notifications, job postings, profiles, etc., other types of entities, such as companies, organizations, institutions, associations, cohorts, or groups of entities, and/or to potential sources of signals such as devices, networks, systems, components, processes, models, robots, or agents.

Responsive to receiving electronic transmissions (e.g., data signals and/or control signals) via one or more components of the environment 101, the application interface 102 stores the data signals and/or control signals using one or more data stores. In some examples, entity content 104 is stored in a first data store (e.g., a searchable database or repository of documents, descriptive content, or web pages), and entity activity signals 106 are stored in a second data store (e.g., a real-time data store for streaming interaction data such as a log file).

Examples of entity content 104 include digital content items such as entity profile pages, articles, posts, comments, documents (e.g., resumes, training materials, manuals, brochures, etc.), videos, images, etc. that provide information about a given entity, such as a user of the application system 132. In some examples, entity content 104 includes content that is applicable to multiple different prediction tasks, such as entity profile information, information about an entity's preferred devices (e.g., web or mobile) or messaging channels, etc.

Examples of entity activity signals 106 include logs of entity interactions with the application system 132 via the application interface 102. An example entry in the log includes structured data that identifies an entity (e.g., entity E1), an action taken by first entity within the application system 132 (e.g., action A1), a content item involved in the action (e.g., content C2), an indication of whether or not an action was taken by the entity during the action (e.g., 0 if no action, 1 if there was an action), and a timestamp associated with the log entry (e.g., timestamp t1). In some examples, a log entry includes a row of comma delimited values.

In the example of FIG. 1, the entity activity signals 106 are related to an entity (e.g., entity E1). Each row in a log of entity activity signals 106 indicates an occurrence of an activity, and a log of entity activity signals 106 includes a temporal sequence of activities. Examples of activities include but are not limited to mouse clicks, keyboard or keypad entries, taps, scrolls, swipes, pinches, and other methods of interacting with a touch screen, physical movement detected by a sensor, voice detected by a microphone, or any other method by which input or communication signals are provided to a computing system.

In some examples, the application system 132 includes an online platform such as a social media service, and entity activity signals 106 include historical data, such as a history of actions related to search activity such as job searching, profile updates, connection requests, content posting, etc. In some examples, the application system 132 includes a fraud detection system and entity activity signals 106 includes a history of actions related to different types of financial transactions and user accounts monitored by the fraud detection system. In some examples, the application system 132 includes a network security system and entity activity signals 106 includes a history of network communications sent and received over a network being monitored by a network security system. In some examples, entity activity signals 106 includes a historical sequence of physical movements or operations performed by a physical device such as a robot or vehicle.

Application system 132 includes an entity content data store 108, an entity activity data store 110, an activity pre-processor 112, a model input generator 114, a recommendation content data store 116, a prompt library 118, a model builder 120, a language model 122, a multi-tower encoder 124 having a context window 125, a fusion layer 126, a representation data store 127, and a recommendation component 130.

Entity content data store 108 and entity activity data store 110 are data stores that receive and store entity content 104 and entity activity signals 106 in association with corresponding entity identifiers for the entities to which the content 104 and activity signals 106 relate. In some examples, the entity content data store 108 and/or entity activity data store 110 includes a real-time data store that captures and stores updates to entity content 104 and/or entity activity signals 106 as they occur; thereby reducing latency associated with the updating of the respective content and/or activity representations produced by the representation learning system 103.

The activity pre-processor 112 prepares the entity activity signals 106 for model input generator 114. As described in more detail with reference to FIG. 2, the entity activity signals 106 are converted to a natural language representation, e.g., a text description of the activities, which is suitable for input to language model 122.

The model input generator 114 formulates model input for the language model 122. During a training phase, denoted as (A) in FIG. 1, model input generator 114 formulates model input used for training the language model 122 via model builder 120, as described in more detail with reference to FIG. 2. During an inference phase, denoted as (B) in FIG. 1, model input generator 114 formulates model input for the language model 122 to generate predicted outcome 128, as described in more detail with reference to FIG. 2 and FIG. 3.

To formulate model input, whether for a training phase or inference phase, model input generator 114 optionally obtains data from entity content data store 108, if available, and obtains natural language representations of activities from activity pre-processor 112, obtains recommendation content from recommendation content data store 116, and obtains prompts from prompt library 118. Prompt library 118 is a data store that stores templates for prompts. A template includes an example prompt and parameters whose values are determined at training time or inference time, as the case may be, by model input generator 114. Examples of prompts and prompt templates are described in more detail with reference to FIG. 2.

As described in more detail with reference to FIG. 2, FIG. 3, and FIG. 5, prompt refers to a type of model input that is formulated for input to language model 122. Each prompt contains an instruction that is designed to cause the language model 122 to identify and extract features from a particular type of model input. For example, if a model input contains entity content 104 of a particular type, such as an entity profile or resume document, the corresponding prompt instructs the language model 122 to look for certain specific pieces of information typically found in that type of content. Similarly, if the model input contains entity activity signals 105 of a particular type, such as search activity, content viewing or sharing activity, or job application activity, the corresponding prompt instructs the language model 122 to look for certain specific pieces of information found in that type of activity.

Recommendation content data store 116 includes a data store that stores digital content items that are candidates for inclusion in a recommendation 134. Such digital content items are referred to as recommendation content. Examples of recommendation content include documents, job postings, feed items, search results, entity profiles, notifications, and multi-modal content such as videos, images, and audio recordings. Other examples of recommendation content include control instructions for a robot, autonomous physical device, or vehicle, warnings for a fraud detection system, and computer programming code or instructions for an agentic system. The types of recommendation content stored in recommendation content data store 116 are variable depending on the type or requirements of application system 132.

Model builder 120 controls the process of training language model 122. As described in more detail with reference to FIG. 2, during a training phase, model builder 120 evaluates output, e.g., predicted outcomes, produced by the language model 122 in response to training input, in relation to expected or ground-truth model output and controls the number of training iterations based on those evaluations. During a training phase, model builder 120 uses those evaluations of the model's performance to adjust the values of weights of the language model 122, as described in more detail with reference to FIG. 2.

A language model is a type of machine learning model that is designed to understand and generate language that is understandable to humans. A language model is trained on a large amount of text data and learns the patterns and structures of language by providing probability distributions over words and/or word sequences. This allows the language model to predict the next word in a sentence or sequence, generate coherent sentences and phrases, and understand the context and meaning of words and phrases. Language model 122 is a machine learning model that includes an encoder. In some examples, language model 122 is a neural network-based model such as a deep learning model, such as but not limited to a transformer model. Language model 122 includes multi-tower encoder 124, fusion layer 126, and context window 125. The multi-tower encoder 124 includes multiple encoder towers, such as transformer-based encoder towers, where each tower corresponds to a model input and produces a machine learning-based representation of the respective model input. The encoder towers each have the same structure in terms of number of nodes, number of layers, and connections between layers, and share their parameters with the other encoder towers. In some examples, language model 122 includes a transformer-based language model, such as a large language model (LLM) pre-trained on causal language encoding to produce embedding representations. The context window 125 of language model 122 is capable of handling long sequences of text as discussed above. That is, the context window 125 has a context length or size that is greater than or equal to a threshold length or size, where the threshold length or size is determined based on the requirements or design of the model input and/or application system 132.

The fusion layer 126 of the language model 122 includes a mathematical operation that evaluates the output of the encoder towers of the multi-tower encoder 124, e.g., the machine learning-based representations of the model inputs, to produce a predicted outcome 128. The fusion layer 126 applies the mathematical operation to the pertinent entity-related machine learning-based representation, on the one hand (e.g., the machine learning-based representation of the entity activity signals 106 and/or entity content 104), and the machine learning-based representation of the recommendation content obtained from recommendation content data store 116, on the other hand, to produce the predicted outcome 128. In some examples, the mathematical operation included in the fusion layer 126 includes a dot product, an inner product, or a Hadamard product. As described with reference to FIG. 5, the fusion layer 126 includes multiple sub-models, with each sub-model fine-tuned for a different prediction type, in some examples.

The representation data store 127 includes a data store that stores machine learning-based representations produced by the multi-tower encoder of the language model 122. During a representation generation phase, denoted as (C) in FIG. 1, machine learning-based representations produced by the encoder towers of the language model 122 (e.g., content representations and activity representations) are generated and stored in representation data store 127. The representation data store 127 is indexed for efficient lookup of machine learning-based representations according to content type (e.g., entity content, recommendation content, entity activity, etc.) during an inference phase, as needed.

During an inference phase, denoted as (D) in FIG. 1, machine learning-based representations are retrieved from representation data store 127 and provided to fusion layer 126, such that entity and activity representations do not need to be computed at inference time unless they are unavailable (e.g., a model input is previously unseen) or the representation needs to be updated (e.g., if new activity has been added to an activity log since the representation was generated).

Recommendation component 130 transforms the predicted outcome 128 produced by the fusion layer 126 of language model 122 into recommendation 134. The method used by recommendation component 130 to prepare the recommendation 134 sometimes depends on the data type of the predicted outcome 128. In some examples, if the predicted outcome 128 is a probability distribution or a list of values, recommendation component 130 selects the top k values from the distribution or list and includes the recommendation content associated with those top k values in the recommendation 134, where k is a positive integer.

In other examples, if the predicted outcome 128 is a point value, such as a score or probability, the recommendation component 130 maps the point value to the associated recommendation content and includes that recommendation content in the recommendation 134. In some examples, recommendation component 130 uses a generative machine learning model (e.g., a transformer-based encoder-decoder model) to formulate the recommendation 134 based on the predicted outcome 128 and the associated recommendation content (e.g., the generative machine learning model is instructed to generate a summary of the recommendation content and/or explanation of the reason for the recommendation). The recommendation component 130 provides the recommendation 134 to the application interface 102 for presentation or communication to one or more components of the environment 101. In some examples the application interface 102 causes the recommendation 134 to be presented at a device (e.g., a user device) running a front end of the application system 132.

In some examples, the recommendation architecture implements a multi-tiered ranking cascade optimized for personalized job discovery. The model pipeline includes a job document index, where attribute-based matching (ABM) and embedding-based retrieval (EBR) states generate initial recommendation sets by incorporating multiple personalization signals such as search query, information from entity profiles, resumes, location, professional qualifications, social graph information, and historical activities on the online platform. These initial recommendations are refined through ranking layers, which progressively apply more sophisticated models to score entity pairs, e.g., job-user pairs. In some examples, a high performance graphics processing unit (GPU)-based model is used for retrieval at the EBR stage, which removes the need for a separate first level ranking layer.

In some examples, the model architecture performs deep learning-based representation learning through embeddings, e.g., continuous, low-dimensional vectors that capture relationships between different entities, such as, in the online jobs platform example, semantic relationships between jobs, user profiles, and user resumes. The model architecture generates and serves these embeddings, transforming texts into dense vector representations. This transformation reduces computational complexity by converting sparse, high dimensional data into manageable dense vectors, captures intricate relationships and patterns in the data to improve recommendation accuracy, enables knowledge sharing across different downstream tasks and models, and facilitates seamless integration across different modeling frameworks. The embeddings produced enable efficient similarity computations and semantic search capabilities.

In some examples, the representation learning platform provides a fine-tuned representation learning pipeline featuring generative machine learning models such as language models, e.g., large language models (LLMs), time-aware embedding generation, and a comprehensive serving architecture. In some examples, fine-tuned pre-trained models expose embedding inference as a remote procedure call (e.g., GRPC) endpoint for nearline inference via nearline processing pipelines, and the nearline embeddings are published to data stores (e.g., key-value stores) for fast access by ranking models.

In some examples, the fine tuning states uses relevance-based labels and engagement-based labels for supervised training. Relevance labels are semantically oriented, enforcing strict matching of role, location, and qualifications. Relevance labels are generated through expert annotation and/or foundation model evaluation with prompt engineering. Engagement labels (e.g., job applications) directly align with domain-specific metrics and user intent. Engagement labels provide larger scale supervision signals that reflect real-world user behavior and platform dynamics.

In some examples, the fine tuning architecture provides a shared base LLM and its tokenizer with specialized prompt templates for different input types (e.g., job descriptions, user profiles, resumes, etc.) The prompt templates act as soft task descriptors, guiding the model's attention to relevant aspects of each text type while maintaining parameter efficiency through weight sharing. In some examples, memory constraints are overcome by using low rank algorithm (LoRA) fine-tuning applied to query-key-value matrices in transformer attention blocks, which makes training parameter efficient. In some examples, specific techniques for fast processing of longer data sequences, and/or a parallel computing platform and application programming interface that allows graphics processing units (GPUs) to be used for accelerated general-purpose processing, and/or a generative artificial intelligence (AI) platform that is capable of supporting secure, private, and trustworthy generative AI solutions, are utilized to ensure efficient forward passes through the LLM on long data sequences. In some examples, techniques for providing mixed precision training and inference are employed to reduce memory usage and speed up computation. In some examples, gradient accumulation across multiple forward passes is used to make effective large batch size training. In some examples, gradient checkpointing is leveraged to trade computation for memory by recomputing intermediate activations during backward passes.

In some examples, the top layers of the model architecture, which model feature interactions, are designed to be lightweight, primarily utilizing a crossing technique and/or stacked non-linear transformations, which enables semantic understanding to be handled by the fine-tuned LLM layers, while downstream feature interactions are minimized and domain-specific. In some examples, the transferability of core LLM capabilities allows for efficient client-side customization.

In some examples, loss function engineering combines three complementary loss functions: binary cross-entropy loss, which is used for the core classification task of apply probability prediction, contrastive loss such as Information Noise Contrastive Estimation (InfoNCE) loss, which is used for retrieval and semantic search tasks, and VP-matrix loss (e.g., a value that represents the summation of errors in a machine learning model, which measures the model's performance), which provides robust outlier handling as well as effective utilization of weak convergence mechanisms in neural network functional space. In some examples, multi-node multi-GPU distributed training is performed using graphical cards.

In some examples, a nearline inference system is designed to produce derived embedding data efficiently. In some examples, the inference system generates embeddings for various types of entities, such as: job postings, user profiles, and user resumes, using separate input streams representing the changelog for each entity, which trigger embedding inference for their respective entities.

In some examples, dedicated real-time pipelines are provided for each entity type, e.g., job postings, member profiles, and member resumes, where each pipeline includes components for source feature extraction, prompt application, change detection, embedding inference, and sink outputs. The source feature extraction component extracts relevant text features from incoming event payloads. The prompt application component applies appropriate LLM prompts to the extracted text. The change detection component skips inference if content has not changed meaningfully from the previous version, to reduce the embedding inference cost. The embedding inference component generates the embedding for the input content via, e.g., a remote procedure call to the LLM. The sink outputs component writes the generated embeddings to appropriate storage destinations.

In some examples, the model is hosted in a model serving clusters with replication for scalability, e.g., the model is deployed as a microservice, exposing remote procedure call endpoints for embedding inference. In some examples, output sinks are used to write the generated embeddings to multiple sinks to support both online and offline use cases. In some examples, embeddings are stored in a high-performance key-value store for real-time access during document ranking. In some examples, generated embeddings are published for use in model training. In some examples, time aware joins are used to fetch the embeddings at the correct point in time for observation data.

In testing, embeddings produced using the described model architecture and techniques have replaced standardized features and shown improvements in multiple different performance metrics for ranking and retrieval models. The described approaches are not limited to recommendation systems but are also capable of being used for searching through query embeddings and/or cross-attention encoders directly, or to improve matching effectiveness with embedding-based retrieval (EBR), and/or other applications needing long context capabilities.

The examples shown in FIG. 1 and the accompanying description are provided for illustration purposes. This disclosure is not limited to the described examples.

FIG. 2 is a component-based flow diagram of an example method for training a language model to jointly learn content and activity representations in accordance with some examples of the present disclosure.

In FIG. 2, portions of a method 200 are performed by various components of a computing system such as the representation learning system 103 of FIG. 1. The method 200 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, portions of the method 200 are performed by one or more computing system components shown in FIG. 1, FIG. 2, FIG. 3, FIG. 4, FIG. 5, one or more components of computing system 700 of FIG. 7, or computer system 800 of FIG. 8. Although shown in a particular sequence or order, unless otherwise specified, the order of the processes is modified in some examples. The processes are performed in a different order, and some processes are performed in parallel, in some examples. Additionally, one or more processes are omitted in various examples. Not all processes are required in every example. Other process flows are possible.

The computing system of FIG. 2 includes an activity template library 205, which stores activity templates such as activity template 204, and includes a combine operation 206, a prompt library 211, which stores prompt templates such as prompt templates 210, and includes a combine operation 212, a combine operation 216, a language model 224, and a model builder 248. The flows shown in FIG. 2 above and leading into model input 218 are performed by a model input generator, such as model input generator 114 of FIG. 1, alone or in combination with an activity pre-processor, such as activity pre-processor 112 of FIG. 1, to generate model input 218.

As described in more detail below, during a training phase, denoted by dotted lines in FIG. 2, a model input 218 includes a label 246 in addition to an activity prompt 220 and a recommendation content prompt 222. During an inference phase, in some examples, a model input 218 includes an activity prompt 220 and a recommendation content prompt 222 but does not include a label 246. In other examples, such as the example of FIG. 1 or FIG. 3, the model input 218 additionally includes an entity content prompt, which is formulated using entity content such as entity content 104.

In the example of FIG. 2, the prompts included in the model input 218 are formulated to cause the language model 224 to generate and output corresponding representations. In other examples, during an inference phase, the step of generating representations is omitted and instead, representations that have been pre-computed using the language model 224 trained as described are retrieved from computer memory such as representation data store 127 of FIG. 1 and provided directly to a fusion layer 238 of the language model 224 (e.g., omitting the representation learning steps).

In FIG. 2, the flows leading into activity prompt 220, denoted as (A), convert activities 202 from a log file to a natural language (NL) representation 208 and formulate the activity prompt 220. In the described examples, an activity involves both an entity (such as a user or device), and a content item (such as a document or multi-modal content item). To convert an activity 202 to a natural language representation of the activity 208, at combine operation 206, a log entry for an activity is read from activities 202, and an activity type 203 is determined for the activity identified in the log entry. The activity type 203 is stored in or obtained via the log entry in some examples. The activity template library 205 is queried using the activity type 203 and an activity template 204 corresponding to the activity type 203 is retrieved from the activity template library 205.

The activity template 204 contains natural language text and placeholders or parameters into which values from the activity log entry are inserted by combine operation 206 to create the natural language representation of activity 208. Table 1 below illustrates some non-limiting examples of activity types and corresponding activity templates.

TABLE 1
Examples of Activity Templates.

| Activity Type | Activity Template |
|---|---|
| Job-Apply | User [EID] [did/did not] apply for job [CID] |
| | at [timestamp] |
| Content-View | User [EID] [did/did not] view content [CID] |
| | at [timestamp] |
| Device-Control | Entity [EID] [did/did not] execute control |
| | instructions [CID] at [timestamp] |
| Network-Event | Entity [EID] [did/did not] send |
| | communication [CID] to network [NID] at |
| | [timestamp] |

In each example of Table 1, the text within the brackets is replaced with corresponding data from the activity being processed by the combine operation 206. The exact text used for a given template, and the total number of available templates, are both variable depending upon the activity types and applications. The processes performed by combine operation 206 are repeated for each entry in the log of activities 202, e.g., for each row in the log file, a natural language representation of activity 208 is produced based on the associated activity type 203, via the combine operation 206.

The conversion of activities 202 to natural language representations 208 of those activities facilitates use of the language model 224 for representation learning while minimizing the pre-processing of the raw input. Unlike other approaches, the described approaches do not require extensive manual feature engineering on activity logs and do not need to perform additional computations to generate computed features from the activities 202, such as occurrence counts for different activity types or other types of aggregations.

The described approaches also avoid the need to perform mappings of raw data to standardized terms, such as taxonomy look-ups, in some examples. Instead, through use of the NL representations of activities 208 in the activity prompt 220, the described approaches are able to leverage the language model 224 to learn to distinguish between features of the activities 202 that are more highly correlated with specific predicted outcomes and other features of the activities 202 that are less highly or not correlated with those outcomes, and then use those learnings to determine which features to extract or compute from the raw input, for a given prediction task.

At combine operation 212, NL representations of activities 208 are concatenated together and combined with a prompt template 210 to produce an activity prompt 220. The prompt template 210 is obtained by querying the prompt library 211 based on a content type 207. For activities, the content type is “activity.” The prompt template 210 for activities, referred to as an activity prompt template, contains a language model instruction, e.g., a prefix instruction, and placeholders or parameters into which the concatenated NL representations of activities 208 are inserted by combine operation 212 to create the activity prompt 220.

In the case of activities 202, the activity prompt template 210 contains an instruction that is formulated to cause the language model 224 to interpret and process the NL representations of activities 208 as a history of activities involving an entity and various content. Thus, an activity prompt template could include a prefix such as “The following is a history of user interactions with content items within the application system. Read the interaction history and focus on the types of activities that were and were not performed. Summarize the activity history for each activity type.” At combine operation 212, the prefix instruction is combined with the NL representations of activities 208 for all of the activities 202 in the activity log that are to be included in the activity prompt 220 (e.g., all or a subset of the activities in the activity log are included in the activity prompt 220, depending upon the application requirements). The combine operation 212 outputs the activity prompt 220, including the prefix instruction and the NL representations of activities 208, for inclusion in the model input 218.

The flows leading into recommendation content prompt 222, denoted as (B), formulate the recommendation content prompt 222 from an item of recommendation content 214 and a content prompt template. The recommendation content 214 is a piece of content that is potentially eligible to be included in a recommendation. The recommendation content 214 has an associated content type 209, which is determined from the recommendation content 214 or from associated metadata. At combine operation 216, the content type 209 is used to query the prompt library 211 for a content prompt template 210 related to the content type 209.

In the case of content items such as recommendation content 214, the content prompt template 210 contains an instruction, e.g., a prefix instruction, that is formulated to cause the language model 224 to interpret and process the recommendation content 214 to identify and extract features from the recommendation content 214 in accordance with the associated content type 209.

The content prompt template 210 instruct the language model 224 to determine the types of information to search for within the input content (e.g., recommendation content 214) and to obtain and use to create the machine learning-based representations (e.g., embeddings) of the content. The instructions in the content prompt template 210 also identify the content type to contextualize the input content for the language model 224 so that the content prompt 222 is fed into the appropriate encoder tower of the language model 224.

In some examples, the instruction prefix is omitted from the content prompt 222 such that the content prompt 222 only includes the input content (e.g., recommendation content 214) without any prompt template.

Table 2 below illustrates some non-limiting examples of content types and corresponding content prompt templates.

TABLE 2
Examples of Prompt Templates.

| Content Type | Prompt Template |
|---|---|
| Job-Posting | “The following is a job posting. [JP] Read the |
| | job posting and focus on the job |
| | requirements. Consider how this information |
| | might be important to job applicants.” |
| Content-View | “The following is a content item. [C1] Read |
| | the content item and focus on the main idea. |
| | Consider how this information might be |
| | useful in determining whether a person would |
| | be interested in reading the article.” |
| Device-Control | “The following is a control instruction. [C1] |
| | Read the control instruction and focus on the |
| | exact instruction. Consider how this |
| | information might be important in |
| | determining whether a device should execute |
| | the instruction.” |
| Network-Event | “The following is a network message. [M1] |
| | Read the network message and focus on the |
| | body of the message. Consider how this |
| | information might be important in |
| | determining whether a network security event |
| | has occurred.” |

In each example of Table 2, the text within the brackets is replaced with corresponding data from the recommendation content 214 being processed by the combine operation 216. The exact text used for a given template, and the total number of available templates, are both variable depending upon the content types and applications.

At combine operation 216, the prefix instruction from the selected content prompt template 210 is combined with the recommendation content 214. The combine operation 216 outputs the recommendation prompt 222, including the prefix instruction applicable to the content type 209 and the recommendation content 214, for inclusion in the model input 218. The processes performed by combine operation 216 are repeated for each item of recommendation content 214, e.g., for each item of recommendation content 214, a recommendation content prompt 220 is produced based on the associated content type 209, via the combine operation 216.

While the prompt generation process denoted by (B) is described with reference to recommendation content 214, the same or similar process is usable to generate similar content prompts for other types of content, such as various different types of entity content 104 described with reference to FIG. 1. For example, if an entity profile or resume is available in addition to the entity's activity log, the prompt generation process denoted by (B) is used in a similar way to generate an entity content prompt, e.g., by combining the entity content with a prompt template 210 according to the content type. In that case, the language model 224 would include an additional encoder tower to generate a machine learning-based representation of the entity content, as described with reference to FIG. 3.

The prompt generation processes denoted by (A) and (B) are repeatable on a large scale for many (e.g., millions or hundreds of millions) different entities and many (e.g., millions or hundreds of millions) different recommendation content items.

In some examples, one or more of the prompt generation processes (A) or (B) are performed at inference time. In those examples, the recommendation content 214 does not have an associated label 244, and as such, label 246 is not included in the model input 218 at inference time.

During a training phase, the model input 218 includes a label 246. The label 246 corresponds to the label 244 associated with a training example of recommendation content 214. Thus, a training instance of model input 218 includes an activity prompt 220, a recommendation content prompt 222, and a label 246 associated with a recommendation content 214. The label 246 is a representation of the label 244 that is suitable for input to the language model 224. The label 244 is a known or actual activity signal associated with the recommendation content 214 from a previous interaction, such as a click or no click signal, a positive or negative signal, etc.

Turning now to architecture of the language model 224, language model 224 is a large language model, in some examples. Language model 224 includes a number of encoder towers that corresponds to the number of model inputs excluding the label 246. In the example of FIG. 2, there are two encoder towers each corresponding to a different portion of model input 218: first encoder tower 226 and second encoder tower 232. Each encoder tower is a transformer-based neural network encoder model having an input layer, an output layer, and a number of hidden layers between the input layer and the output layer. Thus, first encoder tower 226 has an input layer 228, hidden layers, and an output layer 230, and second encoder tower 232 has an input layer 234, hidden layers, and an output layer 236.

Encoder models use only the encoder portion of a transformer model (e.g., the decoder portion of the transformer model is disabled) or the decoder is omitted from the transformer model. Encoder models convert sequences of tokens (e.g., words or n-grams) to machine learning-based (e.g., fixed-size vector) representations of those sequences. An example of a transformer-based encoder is described with reference to FIG. 5.

In language model 224, first encoder tower 226 is trained to generate and output activity representations 260 in response to activity prompts 220, and second encoder tower 232 is trained to generate content representations 262 based on recommendation content prompts 222. In operation, the activity prompt 220 portion of model input 218 is input or received by input layer 228 and the corresponding activity representation 260 is output by output layer 230 of first encoder tower 226. The recommendation content prompt 222 portion of the model input 218 is input or received by input layer 234 and the corresponding content representation 262 is output by output layer 236 of second encoder tower 232.

The language model 224 also includes a fusion layer 238. The fusion layer includes an operation that takes the activity representation 260 and the content representation 262 as input and produces and outputs a predicted outcome 240. The operation applied to the representations 260, 262 at the fusion layer 238 measures similarity of the representations 260, 262 according to a desired similarity criterion. Examples of operations capable of being used at fusion layer 238 to generate predicted outcome 240 include Hadamard product, dot product, inner product, and other suitable operations.

The predicted outcome 240 comprises a probability of occurrence of a particular outcome related to a particular prediction type; for example, the likelihood of a user submitting a job application in response to a job posting, or the likelihood of a user clicking on a content item, or the likelihood of an autonomous or semi-autonomous device needing to execute a particular instruction, or the likelihood of a network receiving a particular communication, etc. In some examples, such as described with reference to FIG. 4, the fusion layer 238 includes multiple different fusion sub-models that are each fine-tuned for a different prediction type.

During a training phase, denoted by (D), a model builder 248 controls the training process by evaluating the performance of the language model 224, adjusting weights of the language model 224, and determining the number of training iterations are executed before the language model 224 is considered trained (e.g., converges, such as when the changes in the model's prediction performance from one iteration to the next are smaller than a maximum tolerable amount of variation).

The model builder 248 includes a decision block 242, a loss function 250, and a backpropagation component 254. The decision block determines whether the language model 224 is in a training phase or an inference phase. During a training phase, denoted by (D), the loss function 250 evaluates the predicted outcome 240 produced by the language model 224 in comparison to the corresponding label 246. The loss function 250 includes a cross-entropy loss function, in some examples. The backpropagation component 254 computes amounts by which the weights of the nodes within the language model 224 are to be adjusted based on the loss 252. The backpropagation component 254 includes an optimization algorithm such as stochastic gradient descent, which is used to determine weight adjustments 256. The model builder 248 causes the weight adjustments 256 to be applied to the respective portions of the language model 224, denoted by (F), before the next training iteration begins. The training is repeated with additional training instances of model input 218 until the language model 224 achieves the desired predictive performance. After training, denoted as (E), the language model 224 is applied to new instances of model input 218. Model output produced after training is stored and/or provided to an application system. For example, activity representations 260 and content representations 262 are stored in one or more data stores, such as representation data store 127, and predicted outcome 240 is provided to an application system.

During a training phase, portions of the language model 224 are fine tuned for different prediction types using different sets of training data, in some examples. For instance, a first training data set includes labels 246 that pertain to positive and negative signals for a first prediction type while a second training data set includes labels 246 that pertain to positive and negative signals for a second prediction type.

During a training, the weigh adjustments 256 are backpropagated all the way back into the language model 224 so that the weight adjustments 256 adapt the predictive output of the language model 224 specifically to the features of the model input that have the most predictive power as evidenced by the activity data.

Whereas other approaches generate content embeddings independently from activity sequences, the described approaches train one model that does both the content modeling and learns the activities within the same language model. For instance, the same language model is initialized with content embeddings and then optimized for activity prediction by backpropagating the activity signals.

The described method of training language model 224 is accomplished using raw, also referred to as primary, input such as raw documents, profile data, and activity descriptions, as opposed to computed or engineered features. The raw inputs are used as input arguments to the respective language model prompts. Through the training process, the language model 224 learns how to generate the representations from the historical activities. For example, in a job search application, a user's job search and apply history indicates which jobs the user has applied for, as well as what jobs they dismissed or ignored. This historical activity data indicates to the language model 224 which portions of the model input to prioritize or weight higher or lower when generating the representations. In contrast to applications that use language models to learn semantic meaning of text, the described approaches use the language model 224 to generate representations that are customized for particular entities based on their respective activity histories because through training the activity histories inform the language model as to which aspects of the model input are more or less important with respect to particular prediction types. Thus, the described approaches enable the language model 224 to learn entity-specific preferences (as opposed to learning semantic concepts) based on the entity's respective activities, and those learned entity preferences are incorporated into the representations produced by the language model 224.

Other approaches have attempted to use the generative capabilities of transformer models to generate predictions based on similarity of entities. In those approaches, the generative model is provided with a prompt that includes the entity data, the recommendation content, and an instruction in the form of a question that asks the model to generate a predicted outcome based on the entity data and the recommendation content provided, in a generative fashion. This approach is impractical for large online platforms that generate millions of predictions for millions of entities and content items every day. For instance, it is computationally impractical to ask the same question millions of times for each entity and content item.

In contrast, the described approaches train a language model to generate predictions using embeddings generated by encoders that have been trained on activity histories that pertain to the desired predictions, i.e., by optimizing the encoder process for recommendations using the pertinent activity histories. The described approaches are capable of regenerating the embeddings as the underlying raw input is updated. These embeddings are specially trained as described so that the language model is also able to generate the desired predictions at scale, making it suitable for large recommendation systems.

The examples shown in FIG. 2 and the accompanying description are provided for illustration purposes. This disclosure is not limited to the described examples.

FIG. 3 is a component-based flow diagram of an example method for predicting an outcome using machine learning-based content and activity representations generated by a language model in accordance with some examples of the present disclosure.

In FIG. 3, a method 300 uses a multi-tower encoder language model trained as described with reference to FIG. 2 to generate predicted outcomes based on entity data that includes both entity content and activities. The method 300 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, portions of the method 300 are performed by one or more computing system components shown in FIG. 1, FIG. 2, FIG. 3, FIG. 4, FIG. 5, one or more components of computing system 700 of FIG. 7, or computer system 800 of FIG. 8. Although shown in a particular sequence or order, unless otherwise specified, the order of the processes is modified in some examples. The processes are performed in a different order, and some processes are performed in parallel, in some examples. Additionally, one or more processes are omitted in various examples. Not all processes are required in every example. Other process flows are possible.

In FIG. 3, the method 300 is represented by arrows connecting components of a computing system. The illustrated computing system includes an activity pre-processor 312, a model input generator 314, and a language model 354.

The activity pre-processor 312 takes as input an activity 302 from an activity log and outputs a natural language (NL) representation of activity 308. As described in more detail with reference to FIG. 2, each activity 302 is converted to a natural language representation, e.g., a text description of the activity, which is suitable for input to a corresponding encoder tower of language model 354.

The model input generator 314 formulates model input 318 for the language model 354. To formulate model input 318, model input generator 314 receives as input entity content 304, natural language representations of activities 308 from activity pre-processor 312, and recommendation content 306. In the example of FIG. 3, model input generator 314 generates a separate model input prompt for each of the different raw content types; e.g., model input generator 314 generates an entity content prompt 320 from entity content 304, and generates an activity prompt 322 from the NL representation of activity 308, and generates a recommendation content prompt 324 from recommendation content 306.

In other examples, the different types of raw entity content are combined into a single model input for the entity; e.g., model input generator 314 combines entity content 304 and NL representation of activities 308 and generates a single entity prompt which is input to a corresponding encoder tower of language model 354. In those examples, the number of encoder towers is reduced in accordance with the number of raw inputs in the model input 318.

The determination as to whether to separate or combine different raw entity inputs is dependent upon design or engineering requirements, such as the stability of the input type (e.g., the frequency at which the input changes or is updated), or data ownership, security, or privacy considerations with respect to the different inputs. For example, treating activity data separate from other information about a user (e.g., profile, resume, etc.) allows the activity representations to be updated more frequently, as the user performs activities, while the content representations may be updated less frequently, as changes to the user profile or resume may be made less frequently. This helps conserve computing resources because the content embeddings and activity embeddings can be recomputed at different time intervals or frequencies. As another example, inputs that are owned by different entities may be kept separate for security, privacy, maintenance, or other reasons.

In creating the model input 318, the model input generator 314 wraps each of the raw inputs 302, 304, 306 in a respective language model prompt using the approaches described with reference to FIG. 2. For instance, the entity content prompt 320 includes instructions and/or examples readable by the language model 354 as to how to generate the corresponding entity content representation 344; the activity prompt 322 includes instructions and/or examples readable by the language model 354 as to how to generate the corresponding activity representation 346; and the recommendation content prompt 324 includes instructions and/or examples readable by the language model 354 as to how to generate the corresponding recommendation content representation 348.

The language model 354 is a large language model such as a transformer-based encoder model. The language model 354 includes a first encoder tower 332, a second encoder tower 338, a third encoder tower 326, and a fusion layer 350. Each encoder tower 332, 338, 326 includes a respective input layer 334, 340, 328, respective hidden layers, and a respective output layer 336, 342, 330.

Each of the prompts 320, 322, 324 is received by a corresponding input layer of a respective encoder tower that has been trained on the same type of input. For example, during training, first encoder tower 332 is trained on activities, second encoder tower 338 is trained on recommendation content, and third encoder tower 326 is trained on entity content. Thus, at inference time, the input layer 334 of first encoder tower 332 receives as input activity prompts 322 including NL representations of activities 308; the input layer 340 of second encoder tower 338 receives as input recommendation content prompts 324 including recommendation content 306, and the input layer 328 of third encoder tower 326 receives as input entity content prompts 320 including entity content 304.

In the method 300, each of the encoder towers generates and outputs a machine learning-based representation in accordance with its respective input and the model's training. Thus, the output layer 330 outputs entity content representations 344 corresponding to the entity content 304 in accordance with the entity content prompt 320; the output layer 336 outputs activity representations 346 corresponding to the NL representations of activities 308 in accordance with the activity prompt 322; and the output layer 342 outputs recommendation content representations 348 corresponding to the recommendation content 306 in accordance with the recommendation content prompt 324.

In some examples, the fusion layer 350 combines the entity-related representations, e.g., via concatenation, to create an entity representation, and then interacts the entity representation with the recommendation content representation (using, e.g., an operation such as Hadamard product) to produce the predicted outcome 352. Thus, in some examples, the combination of entity content representation 344 and activity representation 346 is interacted with the recommendation content representation 348 to produce the predicted outcome 352. In other examples, a determination is made as to which of the entity inputs is to be interacted with the recommendation content representation 348 based on the prediction type. For instance, some prediction types use entity content representation 344 but not activity representation 346 to interact with recommendation content representation 348, while other prediction types use activity representation 346 but not entity content representation 344 to interact with recommendation content representation 348. These and other flexible aspects of the language model 354 and representation learning system are described in more detail with reference to FIG. 4.

The examples shown in FIG. 3 and the accompanying description are provided for illustration purposes. This disclosure is not limited to the described examples.

FIG. 4 is a component-based flow diagram of an example method for designing, building, storing, and using a language model with multiple encoder towers in accordance with some examples of the present disclosure.

In FIG. 4, a method 400 configures a language model for joint content and activity representation learning and prediction based on a number of different design criteria. The method 400 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, portions of the method 400 are performed by one or more computing system components shown in FIG. 1, FIG. 2, FIG. 3, FIG. 4, FIG. 5, one or more components of computing system 700 of FIG. 7, or computer system 800 of FIG. 8. Although shown in a particular sequence or order, unless otherwise specified, the order of the processes is modified in some examples. The processes are performed in a different order, and some processes are performed in parallel, in some examples. Additionally, one or more processes are omitted in various examples. Not all processes are required in every example. Other process flows are possible.

In FIG. 4, a language model 412 is selected as a base model. The language model 412 includes a transformer-based multi-tower large language model (LLM) in some examples. The architecture of the language model 412 is optimized to jointly learn representations of both content (e.g., query text, job postings text, user profile texts, and user resume texts) and activities (e.g., user actions such as apply, save, and dismiss actions on job postings) and fine tune those representations for one or more prediction tasks.

At operation 410, the language model 412 is designed and built in accordance with one or more prediction types 402, input types 404, input characteristics 406, and/or engineering constraints 408. The number of different prediction types 402, or prediction tasks, is one potential design consideration. If the language model 412 is to be fine-tuned for multiple different prediction types 402, the fusion layer 442 includes multiple different sub-models, where each sub-model of the fusion layer 442 contains an operation (e.g., Hadamard product, etc.), which is fine-tuned for a specific prediction type 402 and generates a predicted outcome based on representation inputs that are specific to its particular prediction type 402.

Alternatively, the fusion layer 442 is designed to handle multiple different prediction types via a single sub-model that is generalized across the different prediction types. Thus, as shown in FIG. 4, fusion layer 442 includes up to N prediction type sub-models 444, 446, 448, 450, 452, 454, where N is a positive integer, and the value of N optionally corresponds, or is less than or equal to, the number of different prediction types 402. In one specific example related to an online system, the prediction types 402 include click probabilities (e.g., pCTR) related to different types of activities and/or fit scores that are not related to engagement (e.g., similarity predictions, matching scores, relevance).

Other potential design considerations include input types 404, input characteristics 406, and engineering constraints 408. These design considerations individually or collectively influence the number of encoder towers in the language model 412.

Input types 404 refers to the types of entity-related inputs potentially available to the model. For example, a new user of an online system may have a user profile but little or no activity history. In some cases, the number of input types 404 is dependent upon the prediction type 402. For instance, if the prediction type 402 is whether a user is likely to apply for a job, the input types 404 include the user's activity history related to online job postings. If the prediction type 402 is whether a user is qualified for a job, the input types 404 include the user's profile information and/or resume. In some examples, there is a one to one correspondence between the number of input types 404 and the number of encoder towers in the language model 412. In other examples, the number of encoder towers in the language model 412 is less than the number of input types 404, due to other considerations such as input characteristics 406 and/or engineering constraints 408.

Input characteristics 406 refers to characteristics of the different input types 404. Examples of input characteristics 406 include data stability (e.g., how frequently does the data change or get updated or added to) and data ownership. Input types 404 that are updated frequently or have low stability may be more likely to be assigned to their own encoder tower while input types that are updated less frequently or have high stability may be more likely to be combined such that the combination of those inputs are assigned to a single encoder tower. Input types 404 that have different owners may be more likely to be assigned to different encoder towers.

Engineering constraints 408 refers to considerations such as the time or effort needed to recompute embeddings for particular input types, time and effort required to train and maintain the language model 412, computational or storage capacity of the computing system, or other factors. Engineering constraints 408 may reduce or increase the number of encoder towers in the language model 412.

The output of operation 410 is a version of language model 412 that has been constructed in accordance with relevant design considerations, e.g., prediction types 402, input types 404, input characteristics 406, and/or engineering constraints 408. The resulting language model 412 has up to N entity content encoder towers 416, 422, an entity activity encoder tower 428, and a recommendation content encoder tower 434, where in this case, N is zero or a positive integer. Each of the encoder towers 416, 422, 428, 434 has a corresponding input layer 418, 424, 430, 436 and respective output layer 420, 426, 432, 438.

The use of N herein to mean any number is dependent upon each specific context in which it is used, such that the value of N may be the same or different in different contexts. For example, the number N of sub-models of fusion layer 442 need not be the same as the number N of encoder towers. As discussed above, different considerations may inform the determination of the number of sub-models of the fusion layer 442 and the number of encoder towers.

In a specific, nonlimiting example, the language model 412 is a multi-tower model that supports long context windows, with one to one correspondence between the number of inputs and the number of towers, where each of the towers shares the same encoder architecture and parameters. In this example, each tower takes one of five different inputs: query text, job posting text, user profile texts, user resume texts, and user job posting activity texts.

The user job posting activity is converted to a text format via pre-processing such as “User applied to job posting with Title: W, Company: X, Description: . . . ; then saved job posting with Title: Y, Company Z, Description: . . . ” For example, a user's job activity text includes a history of job activity, such as the job titles of last 10 jobs the user applied for and job descriptions or summaries of the job descriptions. A template is used to join the job activities together into a natural language description of the job activity history, e.g., using concatenation and fill words. The job posting text is the job posting that is being ranked for the user to determine whether to include that job posting in a recommendation for that user.

Each tower of the LLM computes a dense embedding vector for its respective input. The embeddings produced by the towers are interacted together to generate predict outcomes, such as the likelihood of a user clicking on a job posting and submitting a job application. The entire language model 412 is fine tuned to the task-specific activity data (e.g., click log data) to jointly optimize the content and activity representations.

Once the language model 412 is constructed and trained, FIG. 4 illustrates operations that may be included in the use of the model. For example, an optional operation 414 includes mapping model input to encoder towers based on content type. This mapping operation ensures that each input type is provided to the encoder tower that has been trained on data of that same type. The mapping is implicit or explicit, in various embodiments. For instance, the language model prompt or prefix instruction for a given input type is formulated to include instructional language that identifies the content type to the language model 412.

An optional operation 440 includes mapping machine learning-based representations output by the encoder towers to the relevant fusion sub-models based on prediction type. This mapping operation ensures that the prediction sub-models receive as input the machine learning-based representations that are needed to generate their respective prediction types. For example, a sub-model that predicts whether a user is likely to apply for a job takes as input the user's job activity history while a different sub-model that predicts whether a user is a good fit for a job takes as input the user's resume.

An operation 458 uses encoder towers to compute activity and content representations. For example, the encoder towers are used to pre-compute and update embeddings as the model input changes. These processes of computing and recomputing the embeddings can occur independently of the prediction operations of the fusion layer 442.

As indicated by operation 460, the activity and content representations computed by the encoder towers of the language model 412 are stored in memory for subsequent retrieval and use in prediction generation, in some examples. Alternatively or in addition, these representations are passed to the fusion layer 442 to compute predicted outcomes for one or more of the prediction types, as indicated by operation 462. This flexible architecture enables the content and activity representations to be precomputed asynchronously and stored to minimize the amount of computation at runtime and facilitate rapid online recommendations.

The examples shown in FIG. 4 and the accompanying description are provided for illustration purposes. This disclosure is not limited to the described examples.

FIG. 5 is a block diagram of an example encoder neural network in accordance with some examples of the present disclosure. In some examples, portions of the neural network of FIG. 5 are included in one or more computing system components shown in FIG. 1, FIG. 2, FIG. 3, FIG. 4, computing system 700 of FIG. 7, or computer system 800 of FIG. 8.

In FIG. 5, a neural network with attention 500 is embodied in one or more non-transitory computer-readable media, e.g., memory. The neural network with attention 500 includes a transformer model 542.

A transformer model is a deep neural network model that uses a computer-implemented function called attention or self-attention to detect relationships and dependencies among data elements in a sequence. The attention mechanism facilitates the detection of relationships and dependencies between words, phrases, or tokens in a model input by enabling the model to assign different weights, e.g., attention weights, to different portions of the model input based on the detected relationships and dependencies.

There are different kinds of attention mechanisms. A self-attention mechanism is a type of attention mechanism that enables a machine learning model to determine the context of each word or token in relation to every other word or token in a model input, thereby capturing dependencies and relationships between words or tokens across the model input. A multi-head attention mechanism is a type of self-attention mechanism that enhances the model's ability to process input sequence because it contains multiple attention heads instead of a single attention head. Instead of relying on a single attention head, which computes weighted sums of portions of the model input based on their relationships to specific context, multi-head attention employs multiple attention heads simultaneously, where each of the attention heads processes different portions of the model input in parallel. The outputs of the multiple attention heads are combined to provide a more complex interpretation of the model input that may improve the model's performance across various tasks.

FIG. 5 illustrates a transformer-based architecture that includes self-attention layers, feed-forward layers, and residual connections between the layers. The exact number and arrangement of layers of each type as well as the hyperparameter values used to configure the model are variable based on the requirements of a particular design or implementation.

In the example of FIG. 5, the transformer model 542 is constructed using a neural network-based machine learning model architecture including an encoder 544. The encoder 544 includes one or more attention mechanisms. The encoder 544 includes a multi-head attention layer 545.

In the transformer model 542, feed-forward layers (e.g., feed-forward layer 547) follow the attention mechanisms in the encoder 544. In the context of transformer models, feed-forward layers are sub-units within the encoder and decoder, respectively. A feed-forward layer itself includes a fully-connected neural network that applies a transformation (e.g., a non-linear transformation) to the output of an attention mechanism. The transformation applied by the feed-forward layer may enable the model to determine more complex patterns within the data to improve the model output.

In the transformer model 542, a residual connection (e.g., add & norm layer 546, add & norm layer 548) follows each of the attention mechanisms and feed-forward layers, respectively. In the context of transformer models, residual connections are used to ensure that original input information is retained and integrated with transformed outputs produced by the respective attention mechanisms and feed-forward layers, and to potentially speed up the model training process using normalization.

In operation, transformer model 542 feeds respective input and output portions of model input 550 into encoder 544. For example, transformer model 542 feeds portions of model input 550 into multi-head attention layer 545 of encoder 544.

As shown in FIG. 5, encoder 544 includes multi-head attention layer 545, add & norm layer 546, feed-forward layer 547, and add & norm layer 548. Multi-head attention layer 545 receives inputs of model input 550 and computes output representations 552 for the respective portions of model input 550. In some examples, multi-head attention layer 545 converts portions of model input 550 into queries, keys, and values using query, key, and value matrices. Multi-head attention layer 545 computes the output representation of the inputs of model input 550 as a weighted sum of the values of all of the inputs of model input 550. Multi-head attention layer 545 computes the weights for the weighted sum by applying a compatibility function to the corresponding key and query for the value. In some examples, multi-head attention layer 545 uses a scaled dot product on the key and query of an input of model input 550 to determine a weight to apply to a value of the input. Multi-head attention layer 545 includes multiple attention blocks which each compute an output representation for the inputs of embedded subsequences. Multi-head attention layer 545 aggregates the output representations of these attention blocks to generate a final output representation for multi-head attention layer 545.

Transformer model 542 feeds the output representation generated by multi-head attention layer 545 and residual connections from the inputs of model input 550 into add & norm layer 546. The residual connections prevent the transformer model 542 from “forgetting” features of model input 550 during training. Forgetting in the context of machine learning means that as the model continues to be sequentially trained on different datasets, the model continually adjusts the values of feature coefficients based on the most recent datasets, thereby potentially losing or diluting the effect on those coefficient values of the datasets used earlier in training.

In some examples, add & norm layer 546 sums the output representation generated by multi-head attention layer 545 and the residual connections from inputs of model input 550 and applies a layer normalization to the result. In some examples, the add & normal layers apply a SoftMax function to generate action probabilities for the inputs of model input 550. In some examples, add & norm layer 546 generates estimated probabilities \hat{p}(aₖ|s), where aₖ is the action policy and s is the state features.

Transformer model 542 feeds the normalized output of add & norm layer 546 into feed-forward layer 547. Feed-forward layer 547 is a feed-forward network that receives and passes the normalized output of add & norm layer 546, through the hidden layers of feed-forward layer 547, and feeds the output of feed-forward layer 547 to add & norm layer 548. Feed-forward layer 547 processes the information received from add & norm layer 546 and updates the hidden layers of feed-forward layer 547 based on the information (e.g., during training) and/or generates an output based on the hidden layers processing the information (e.g., during evaluation and/or inference). In some examples, during training, transformer model 542 updates the weights of the hidden layers of feed-forward layer 547 based on the inputs and the loss of the transformer system. In other examples, during evaluation and/or inference, the weights of the hidden layers of feed-forward layer 547 are used to determine the output representation 552 of each of the inputs of model input 550.

Transformer model 542 feeds the output of feed-forward layer 547 into add & norm layer 548 as well as residual connections from the output of add & norm layer 546. Add & norm layer 548 sums the output of feed-forward layer 547 with the residual connections from add & norm layer 546 and applies a layer normalization to the result to generate output of the add & norm layer 548.

In some examples, the neural network with attention described herein includes or is based on one or more transformer models, one or more pre-trained transformer (GPT) models, one or more bidirectional encoder representations from transformers (BERT) models, one or more large language models (LLMs), one or more XLNet models, and/or one or more other natural language processing (NLP) models that significantly advance the state-of-the-art in various linguistic tasks such as machine translation, sentiment analysis, question answering and sentence similarity. In some examples, the neural network-based machine learning model architecture includes or is based on one or more predictive content neural models that is capable of receiving digital content input and generating one or more outputs based on processing the digital content with one or more neural network models. Examples of predictive neural models include, but are not limited to, Generative Pre-Trained Transformers (GPT), BERT, and/or Recurrent Neural Networks (RNNs). In some examples, one or more types of neural network-based machine learning model architecture includes or is based on one or more multimodal neural networks capable of outputting different modalities (e.g., text, image, sound, etc.) separately and/or in combination based on digital content input. Accordingly, in some examples, a multimodal neural network is capable of outputting digital content that includes a combination of two or more of text, images, video or sound.

In some examples, the neural network with attention described herein includes a language model capable of being trained on a large dataset of natural language content. In some examples, training samples of natural language content extracted from publicly available data sources are used to train the language model. The size and composition of the dataset used to train the language model is variable according to the requirements of a particular design or implementation. In some examples, the dataset used to train the language model includes hundreds of thousands to millions or more different natural language training samples. In some examples, the language model includes multiple language models trained on differently sized datasets.

In some examples, model inputs to the neural network with attention described herein include or are in the form of prompts. Prompt engineering is a technique used to optimize the structure and/or content of a prompt input to a language model. Some prompts include examples of outputs to be generated by the language model (e.g., few-shot prompts), while other prompts include no examples of outputs to be generated by the language model (e.g., zero-shot prompts). Chain of thought prompting is a prompt engineering technique where the prompt includes a request that the model explain reasoning in the output. For example, the language model performs the task described in the prompt using a series of steps and outputs reasoning as to each step performed.

In some examples, the neural network with attention described herein is trained using supervised learning. Supervised learning is a method of training (or fine-tuning) a machine learning model given input-output pairs, where the output of the input-output pair is known (e.g., an expected output, a labeled output, a ground truth). Other training methods, including semi-supervised learning or federated learning, are used to train the neural network with attention described herein or to fine-tune the neural network with attention described herein, in some examples.

In some examples, the neural network with attention described herein includes a language model that is trained or fine-tuned by providing a series of prompts as input to the machine learning model. In some examples, a prompt includes natural language instructions, queries, output examples, etc. The model generates output by applying the weights and nodes of the model to the prompt. In some examples, error is determined by comparing the model output to a reference or expected output. In some examples, the similarity between the model output and the expected output is evaluated using a similarity metric or model performance metric. The error is used to adjust the value of weights in a weight matrix included in the language model and/or the number of layers and/or arrangement of layers included in the model.

In some examples, the neural network with attention described herein is trained using a backpropagation algorithm. The backpropagation algorithm operates by propagating the error through each of the algorithmic weights of the model such that the algorithmic weights are adjusted based on the amount of error. In some examples, the error is calculated at each iteration, batch, and/or epoch. The error is computed using a loss function. An example loss function includes the cross-entropy error function. After a number of training iterations, the model converges, e.g., adjusts weight values over time until the model output achieves an acceptable level of accuracy or reliability (e.g., accuracy satisfies a defined tolerance or confidence level). The values of the weights of the trained model (e.g., after convergence) are stored to enable the trained machine learning model to be deployed during inference time.

In some examples, the neural network with attention described herein is configured and implemented as a network service. In some examples, the model is configured using a machine learning library and an application programming interface (API), e.g., via an API call such as ML_library.model(p1, p2, . . . pn), where p indicates a parameter or argument of the call, such as a model hyperparameter or an input identifier. In some examples, the model and/or its output is hosted on one or more servers and/or data storage devices for accessibility to one or more requesting processes, systems, devices, frameworks, or services.

The examples shown in FIG. 5 and the accompanying description, above are provided for illustration purposes. This disclosure is not limited to the described examples.

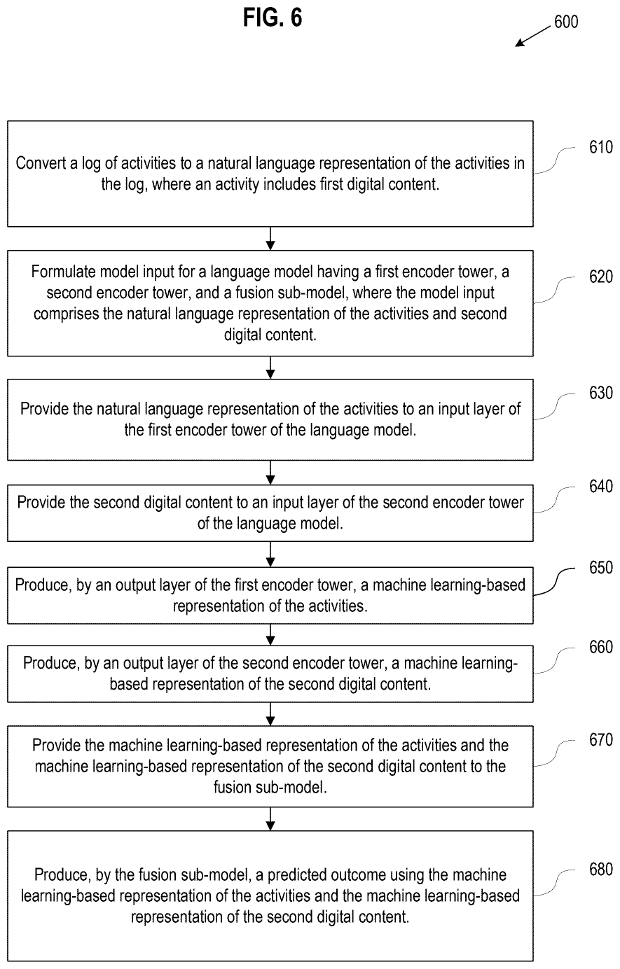

FIG. 6 is a flow diagram of an example method for representation learning using a language model in accordance with some examples of the present disclosure.

In FIG. 6, a method 600 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 600 is performed by the computing system components shown in FIG. 1, FIG. 3, FIG. 4, FIG. 5, one or more components of representation learning system 780 of FIG. 7, or representation learning system 850 of FIG. 8. Although shown in a particular sequence or order, unless otherwise specified, the order of the processes is modified, in some examples. Processes are performed in a different order, and some processes are performed in parallel, in some examples. Additionally, one or more processes are omitted in various examples. Thus, not all processes are required in every example. Other process flows are possible.

At operation 610, the processing device converts a log of activities to a natural language representation of the activities in the log. In some examples, an activity includes first digital content presented to a user via a software application and a signal received by the software application from the user via a device. In some examples, operation 610 is performed using an activity pre-processor, such as activity pre-processor 112 described with reference to FIG. 1 and/or the activity pre-processing portions of FIG. 2 and/or activity pre-processor 312 described with reference to FIG. 3.

At operation 620, the processing device formulates model input for a language model having a first encoder tower, a second encoder tower, and a fusion sub-model. In some examples, the language model includes a context window. In some examples, the model input includes the natural language representation of the activities and second digital content. In some examples, operation 620 is performed using a model input generator, such as model input generator 114 described with reference to FIG. 1 and/or the model input formulating portions of FIG. 2 and/or model input generator 314 described with reference to FIG. 3.

At operation 630, the processing device provides the natural language representation of the activities to an input layer of the first encoder tower of the language model. In some examples, the natural language representation of the activities is provided to the input layer via the context window. In some examples, operation 630 is performed using portions of a language model, such as language model 122 described with reference to FIG. 1 and/or portions of language model 224 described with reference to FIG. 2 and/or portions of language model 354 described with reference to FIG. 3 and/or portions of language model 412 described with reference to FIG. 4.

At operation 640, the processing device provides the second digital content to an input layer of the second encoder tower of the language model. In some examples, operation 640 is performed using portions of a language model, such as language model 122 described with reference to FIG. 1 and/or portions of language model 224 described with reference to FIG. 2 and/or portions of language model 354 described with reference to FIG. 3 and/or portions of language model 412 described with reference to FIG. 4.

At operation 650, the processing device produces, by an output layer of the first encoder tower, a machine learning-based representation of the activities. In some examples, operation 650 is performed using portions of a language model, such as language model 122 described with reference to FIG. 1 and/or portions of language model 224 described with reference to FIG. 2 and/or portions of language model 354 described with reference to FIG. 3 and/or portions of language model 412 described with reference to FIG. 4.

At operation 660, the processing device produces, by an output layer of the second encoder tower, a machine learning-based representation of the second digital content. In some examples, operation 660 is performed using portions of a language model, such as language model 122 described with reference to FIG. 1 and/or portions of language model 224 described with reference to FIG. 2 and/or portions of language model 354 described with reference to FIG. 3 and/or portions of language model 412 described with reference to FIG. 4.

At operation 670, the processing device provides the machine learning-based representation of the activities and the machine learning-based representation of the second digital content to the fusion sub-model. In some examples, operation 670 is performed using portions of a language model, such as language model 122 described with reference to FIG. 1 and/or portions of language model 224 described with reference to FIG. 2 and/or portions of language model 354 described with reference to FIG. 3 and/or portions of language model 412 described with reference to FIG. 4.

At operation 680, the processing device produces, by the fusion sub-model, a predicted outcome using the machine learning-based representation of the activities and the machine learning-based representation of the second digital content. In some examples, the predicted outcome includes a likelihood of the user interacting with the second digital content. In some examples, operation 650 is performed using portions of a language model, including a fusion sub-model such as fusion layer 126 of language model 122 described with reference to FIG. 1 and/or portions of language model 224 including fusion layer 238 described with reference to FIG. 2 and/or portions of language model 354 including fusion layer 350 described with reference to FIG. 3 and/or portions of language model 412 including fusion layer 442 described with reference to FIG. 4.

In some examples, converting the log of activities to the natural language representation of the activities in the log includes: determining an activity type using the signal and the software application; selecting a template using the activity type; and applying the selected template to the log of activities to produce the natural language representation of the activities in the log.

In some examples, formulating model input for a language model includes: including the natural language representation of the activities in a first prompt, where the first prompt includes a first instruction to cause the language model to extract activity features from the natural language representation of the activities; and including the second digital content in a second prompt, where the second prompt includes a second instruction to cause the language model to extract content features from the second digital content. In some examples, the processing device determines a content type of the second digital content; and formulates the second instruction to identify, to the language model, features associated with the content type of the second digital content.

In some examples, the processing device formulates the language model to include up to one encoder tower for each type of input in the model input. In some examples, the processing device trains the language model to optimize the machine learning-based representations for multiple different types of predicted outcomes. In some examples, the processing device, via the fusion sub-model, connects the machine learning-based representation of the activities with a machine learning-based representation of the first digital content.

In some examples, the processing device stores the machine learning-based representation of the activities and the machine learning-based representation of the second digital content in computer memory. In some examples, during an inference phase, the processing device retrieves the machine learning-based representation of the activities and the machine learning-based representation of the second digital content from the computer memory; provides the retrieved machine learning-based representation of the activities and the machine learning-based representation of the second digital content to the fusion sub-model; and provides the predicted outcome to the software application via the fusion sub-model.

In some examples, the processing device determines a prediction type of the predicted outcome; uses the prediction type to determine whether to include third digital content in the model input or exclude the third digital content from the model input, where the third digital content includes content provided by the user via the software application; produces, by a third encoder tower of the language model, a machine learning-based representation of the third digital content; and by the fusion sub-model, uses the machine learning-based representation of the third digital content to generate the predicted outcome in accordance with the prediction type. In some examples, the processing device, during a training phase, backpropagates a loss to weights of the first encoder tower and weights of the second encoder tower to produce a trained language model, where the loss estimates change in a difference between the predicted outcome and an actual outcome involving the second digital content.

The example shown in FIG. 6 and the accompanying description above are provided for illustration purposes. This disclosure is not limited to the described examples.

FIG. 7 is a block diagram of a computing system that includes a representation learning system in accordance with some examples of the present disclosure.

In the example of FIG. 7, a computing system 700 includes one or more user systems 710, a network 720, an application system 730, data resources and tools 750, a representation learning system 780, a data storage system 760, an event logging service 770, and an AI model service 790.

All or at least some components of representation learning system 780 are implemented at the user system 710, in some examples. In some examples, portions of representation learning system 780 are implemented directly upon a single client device such that communications involving applications running on user system 710 and representation learning system 780 occur on-device without the need to communicate with, e.g., one or more servers, over the Internet. Dashed lines are used in FIG. 7 to indicate that all or portions of representation learning system 780 are implemented directly on the user system 710, e.g., the user's client device, in some examples. In other words, both user system 710 and representation learning system 780 are implemented on the same computing device, in some examples. In other examples, all or portions of representation learning system 780 are implemented on one or more servers and in communication with user systems 710 via network 720.

A user system 710 includes at least one computing device, such as a personal computing device, a server, a mobile computing device, a wearable electronic device, or a smart appliance, and at least one software application that the at least one computing device is capable of executing, such as an operating system or a front end of an online system. In some examples, many different user systems 710 are connected to network 720 at the same time or at different times. In some examples, different user systems 710 contain similar components as described in connection with the user system 710. In some examples, many different end users of computing system 700 are interacting with many different instances of application system 730 through their respective user systems 710, at the same time or at different times.

User system 710 includes a user interface 712. User interface 712 is installed on user system 710 or accessible to user system 710 via network 720. In some examples, user interface 712 includes a front end portion of an application software system.

User interface 712 includes, for example, a graphical display screen that includes graphical user interface elements such as at least one input box or other input mechanism and at least one slot. A slot as used herein refers to a space on a graphical display such as a web page or mobile device screen, into which output, e.g., digital content such as search results, feed items, chat boxes, or threads, is loaded for display to the user, in some examples. User interface 712 is configured with a scrollable arrangement of variable-length slots that simulates an online chat or instant messaging session and/or a scrollable arrangement of slots that contain content items or search results, in some examples. The locations and dimensions of a particular graphical user interface element on a screen are specified using, for example, a markup language such as HTML (Hypertext Markup Language). On a typical display screen, a graphical user interface element is defined by two-dimensional coordinates. In other examples, such as virtual reality or augmented reality implementations, a slot is defined using a three-dimensional coordinate system.

In some examples, user interface 712 is used to interact with the representation learning system 780 and/or one or more application systems 730. In some examples, user interface 712 enables the user of a user system 710 to interact with an application software system to create, edit, send, view, receive, process, and organize workflows, tasks, plans, search queries, search results, content items, news feeds, and/or portions of online dialogs. In some examples, user interface 712 enables the user to input requests (e.g., queries) for various different types of information, to initiate user interface events, and to view or otherwise perceive output such as data and/or digital content produced by, e.g., an application system 730, representation learning system 780, content distribution service 738 and/or search engine 740. In some examples, user interface 712 includes a graphical user interface (GUI), a conversational voice/speech interface, a virtual reality, augmented reality, or mixed reality interface, and/or a haptic interface. In some examples, user interface 712 includes a mechanism for entering search queries and/or selecting search criteria (e.g., facets, filters, etc.), selecting GUI user input control elements, and interacting with digital content such as search results, entity profiles, posts, articles, feeds, and online dialogs. Examples of user interface 712 include web browsers, command line interfaces, and mobile app front ends. In some examples, user interface 712 includes application programming interfaces (APIs).

Network 720 includes an electronic communications network. Network 720 is implemented on any medium or mechanism that provides for the exchange of digital data, signals, and/or instructions between the various components of computing system 700. Examples of network 720 include, without limitation, a Local Area Network (LAN), a Wide Area Network (WAN), an Ethernet network or the Internet, or at least one terrestrial, satellite or wireless link, or a combination of any number of different networks and/or communication links.

In some examples, application system 730 includes one or more online systems, such as systems that provide social network services, general-purpose search engines, specific-purpose search engines, messaging systems, content distribution platforms, e-commerce software, enterprise software, network security, fraud detection, device control, or any combination of any of the foregoing or other types of software applications. Application system 730 includes any type of application system that provides or enables the retrieval of and interactions with at least one form of digital content via user interface 712. In some examples, portions of representation learning system 780 are components of application system 730.

In some examples, application system 730 includes an entity graph 732 and/or knowledge graph 734, a connection network 736, a content distribution service 738, and/or a search engine 740. In some examples, application system 730 interacts with representation learning system 780 to control a network, or a physical machine or device, such as a sensor, a vehicle, or a robot.

In some examples, a front end portion of application system 730 operates in user system 710, for example as a plugin or widget in a graphical user interface of a web application, mobile software application, or as a web browser executing user interface 712. In some examples, a mobile app or a web browser of a user system 710 transmits a network communication such as an HTTP request over network 720 in response to user input that is received through a user interface provided by the web application, mobile app, or web browser, such as user interface 712. A server running application system 730 receives the input from the web application, mobile app, or browser executing user interface 712, perform at least one operation using the input, and return output to the user interface 712 using a network communication such as an HTTP response, which the web application, mobile app, or browser receives and processes at the user system 710.

In the example of FIG. 7, application system 730 includes an entity graph 732 and/or a knowledge graph 734. Entity graph 732 and/or knowledge graph 734 includes data organized according to graph-based data structures that can be traversed via queries and/or indexes to determine relationships between entities. In some examples, entity graph 732 and/or knowledge graph 734 is used to compute various types of relationship weights, affinity scores, similarity measurements, and/or statistics between, among, or relating to entities.

Entity graph 732, knowledge graph 734 includes a graph-based representation of data stored in data storage system 760, described herein. For example, entity graph 732, knowledge graph 734 represents entities, such as users, organizations (e.g., companies, schools, institutions), content items (e.g., job postings, announcements, articles, comments, and shares), and computing resources (e.g., databases, models, applications, and services), as nodes of a graph. Entity graph 732, knowledge graph 734 represents relationships, also referred to as mappings or links, between or among entities as edges, or combinations of edges, between the nodes of the graph. In some examples, mappings between different pieces of data used by an application system 730 are represented by one or more entity graphs. In some examples, the edges, mappings, or links indicate relationships, online interactions, or activities relating to the entities connected by the edges, mappings, or links. In some examples, if a user clicks on a search result, an edge is created connecting the user entity with the search result entity in the entity graph, where the edge is tagged with a label such as “viewed.” In some examples, if a user viewing a list of search results skips over a search result without clicking on the search result, an edge is not created between the user entity and the search result entity in the entity graph.

In some examples, portions of entity graph 732, knowledge graph 734 are automatically re-generated or updated from time to time based on changes and updates to the stored data, e.g., updates to entity data and/or activity data. In some examples, entity graph 732 and/or knowledge graph 734 refers to an entire system-wide entity graph or to only a portion of a system-wide graph. In some examples, entity graph 732 and/or knowledge graph 734 refers to a subset of a system-wide graph, where the subset pertains to a particular user or group of users of application system 730.

Knowledge graph 734 includes a graph-based representation of data stored in data storage system 760, described herein. Knowledge graph 734 represents relationships, also referred to as links or mappings, between entities or concepts as edges, or combinations of edges, between the nodes of the graph. In some examples, mappings between different pieces of data used by application system 730 or across multiple different application systems are represented by the knowledge graph 734.

In some examples, knowledge graph 734 is a subset or a superset of entity graph 732. In some examples, knowledge graph 734 includes multiple different entity graphs 732 that are joined by cross-application or cross-domain edges. In some examples, knowledge graph 734 joins entity graphs 732 that have been created across multiple different databases or across different software products. In some examples, the entity nodes of the knowledge graph 734 represent concepts, such as product surfaces, verticals, or application domains. In some examples, knowledge graph 734 includes a platform that extracts and stores different concepts that are used to establish links between data across multiple different software applications. Examples of concepts include topics, industries, and skills. In some examples, knowledge graph 734 is used to compute various types of relationship weights, affinity scores, similarity measurements, and/or statistical correlations between or among entities and/or concepts.

In the example of FIG. 7, application system 730 includes a user connection network 736. User connection network 736 includes, for instance, a social network service, professional social network system and/or other social graph-based applications. Content distribution service 738 includes, for example, a feed, chatbot or chat-style system, or a messaging system, such as a peer-to-peer messaging system that enables the creation and exchange of messages between users of application system 730 and the application system 730. Search engine 740 includes a search engine that enables users of application system 730 to input and execute search queries to retrieve information from one or more sources of information, such as user connection network 736, entity graph 732, knowledge graph 734, one or more data stores of data storage system 760, or one or more data resources and tools 750.

In the example of FIG. 7, application system 730 includes a content distribution service 738. The illustrative content distribution service 738 includes a data storage service, such as a web server, which stores digital content items, and transmits digital content items to users via user interface 712. In some examples, content distribution service 738 processes requests from, for example, application system 730 and/or representation learning system 780, and distributes digital content items to user systems 710 in response to requests.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, an input of a search query, or a page load. In some examples, content distribution service 738 is part of application system 730. In other examples, content distribution service 738 interfaces with application system 730 and/or representation learning system 780, for example, via one or more application programming interfaces (APIs).

In the example of FIG. 7, application system 730 includes a search engine 740. Search engine 740 includes a software system designed to search for and retrieve information by executing queries on one or more data stores, such as databases, connection networks, and/or graphs. The queries are designed to find information that matches specified criteria, such as keywords and phrases contained in user input and/or system-generated queries. For example, search engine 740 is used to retrieve data in response to user input and/or system-generated queries, by executing queries on various data stores of data storage system 760 and/or data resources and tools 750, or by traversing entity graph 732, knowledge graph 734.

Data resources and tools 750 include computing resources, such as data stores, databases, embedding-based retrieval mechanisms, code generators, etc., that are usable to operate a representation learning system. In some examples, data resources and tools 750 include computing resources that are internal to application system 730 or external to application system 730. Examples of data resources and tools 750 include entity graphs, knowledge graphs, indexes, databases, networks, applications, models (e.g., large language models and/or other artificial intelligence models or machine learning models), taxonomies, data services, web pages, vectors (e.g., data stores that store embeddings), and searchable digital catalogs. Each data resource or tool 750 enables a representation learning system to access the data resource or tool, for example by providing an application programming interface (API). In some examples, each data resource or tool 750 includes a monitoring service that periodically generates, publishes, or broadcasts availability and/or other performance metrics associated with the data resource. In some examples, a data resource or tool 750 provides a set of APIs that are used by a representation learning system to access the data resource or tool, obtain output from the data resource, and/or obtain performance metrics for the data resource or tool.

Data storage system 760 includes data stores and/or data services that store digital data received, used, manipulated, and produced by application system 730 and/or representation learning system 780, including contextual data, state data, prompts and/or prompt templates for large language models, user inputs, system-generated outputs, metadata, attribute data, activity data. Examples of databases or data stores include vector databases, graph databases, relational databases, and key-value stores.

In the example of FIG. 7, data storage system 760 includes various data stores that store, for example, entity data, context data, prompts, embeddings, etc. In some examples, a data store includes a volatile memory such as a form of random access memory (RAM) and/or persistent memory. In some examples, the data storage system 760 is available on user system 710 or another device (e.g., one or more servers) for storing state data generated at the user system 710 or an application system 730. In some examples, a separate, personalized version of each or any data store is created for each user such that data is not shared between or among the separate, personalized versions of the data stores.

In some examples, data storage system 760 includes multiple different types of data storage and/or a distributed data service. In some examples, data service refers to a physical, geographic grouping of machines, a logical grouping of machines, or a single machine. In some examples, a data service includes a data center, a cluster, a group of clusters, or a machine. In some examples, data stores of data storage system 760 are configured to store data produced by real-time and/or offline (e.g., batch) data processing. In some examples, a data store configured for real-time data processing is referred to as a real-time data store. In some examples, a data store configured for offline or batch data processing is referred to as an offline data store. In some examples, data stores are implemented using databases, such as key-value stores, relational databases, and/or graph databases. In some examples, data is written to and read from data stores using query technologies, e.g., SQL or NoSQL.

Data storage system 760 resides on at least one persistent and/or volatile storage device. In some examples, data storage system 760 resides within the same local network as at least one other device of computing system 700 and/or in a network that is remote relative to at least one other device of computing system 700. Thus, although depicted as being included in computing system 700, portions of data storage system 760 are part of computing system 700 or accessed by computing system 700 over a network, such as network 720, in some examples.

Event logging service 770 captures and records activity data generated during operation of application system 730 and/or representation learning system 780, including user interface events generated at user systems 710 via user interface 712, in real time, and formulates the user interface events and/or other network activity data into a data stream that is consumed by, for example, a stream processing system. Examples of network activity data include logins, page loads, dialog inputs, input of search queries or query terms, selections of facets or filters, clicks on search results or graphical user interface control elements, scrolling lists of search results, and social action data such as likes, shares, comments, and social reactions (e.g., “insightful,” “curious,” “like,” etc.). For instance, in response to a user of application system 730 entering, via a user system 710, input or clicks on a user interface element, such as a workflow element, or a user interface control element such as a view, comment, share, or reaction button, or uploads a file, or inputs a query, or scrolls through a feed, etc., event logging service 770 fires an event to capture and store log data including an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web applications and mobile applications.

For instance, in response to a user entering input or reacting to system-generated output, such as a list of search results, event logging service 770 stores the corresponding event data in a log. Event logging service 770 generates a data stream that includes a record of real-time event data for each user interface event that has occurred. In some examples, event data logged by event logging service 770 is pre-processed and anonymized as needed so that it can be used as context data to configure machine learning models.

Representation learning system 780 includes any one or more of the components, features, models, or functions described herein with respect to a representation learning system, such as representation learning system 103 described with reference to FIG. 1, the components of the computing system described with reference to FIG. 2, the components of the computing system described with reference to FIG. 3, the components of the computing system described with reference to FIG. 4, the machine learning model described with reference to FIG. 5, and/or the computer system described with reference to FIG. 8.

AI model service 790 includes one or more artificial intelligence-based models, such as large language models and/or other types of machine learning models including discriminative and/or generative models, neural networks, probabilistic models, statistical models, transformer-based models, and/or any combination of any of the foregoing. AI model service 790 enables representation learning systems to access to these models, for example by providing one or more application programming interfaces (APIs). In some examples, AI model service 790 includes a monitoring service that periodically generates, publishes, or broadcasts latency and/or other performance metrics associated with the models. In some examples, AI model service 790 provides a set of APIs that are usable by a representation learning system to obtain performance metrics for large language models and/or other machine learning models served by AI model service 790.

While not specifically shown, it should be understood that any of user system 710, application system 730, data resources and tools 750, data storage system 760, event logging service 770, representation learning system 780, and AI model service 790 includes an interface embodied as computer programming code stored in computer memory that when executed causes a computing device to enable bidirectional communication with any other of user system 710, application system 730, data resources and tools 750, data storage system 760, event logging service 770, representation learning system 780, and AI model service 790 using a communicative coupling mechanism. Examples of communicative coupling mechanisms include network interfaces, inter-process communication (IPC) interfaces and application program interfaces (APIs).

Each of user system 710, application system 730, data resources and tools 750, data storage system 760, event logging service 770, representation learning system 780, and AI model service 790 is implemented using at least one computing device that is communicatively coupled to electronic communications network 720. Any of user system 710, application system 730, data resources and tools 750, data storage system 760, event logging service 770, representation learning system 780, and AI model service 790 are bidirectionally communicatively coupled by network 720, in some examples. User system 710 as well as other different user systems (not shown) are bidirectionally communicatively coupled to application system 730 and/or representation learning system 780, in some examples.

In some examples, a typical user of user system 710 is an administrator or end user of application system 730 or representation learning system 780. User system 710 is configured to communicate bidirectionally with any of application system 730, data resources and tools 750, data storage system 760, event logging service 770, representation learning system 780, and AI model service 790 over network 720.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

Examples of the features and functionality of user system 710, application system 730, data resources and tools 750, data storage system 760, event logging service 770, representation learning system 780, and AI model service 790 are implemented using computer software, hardware, or software and hardware, which include combinations of automated functionality, data structures, and digital data that are represented schematically in the figures. User system 710, application system 730, data resources and tools 750, data storage system 760, event logging service 770, representation learning system 780, and AI model service 790 are shown as separate elements in FIG. 9 for ease of discussion but, except as otherwise described, the illustration is not meant to imply that separation of these elements is required. In some examples, the systems, services, and data stores (or their functionality) of each of user system 710, application system 730, data resources and tools 750, data storage system 760, event logging service 770, representation learning system 780, and AI model service 790 are divided over any number of physical systems, including a single physical computer system, and communicate with each other in any appropriate manner.

In the example of FIG. 8, portions of representation learning system 780 that are implemented on a front end system, such as a user's device or other physical device, and a back end system, such as one or more servers, in some examples, are collectively represented as representation learning system 850. Portions of representation learning system 780 are not required to be implemented all on the same computing device, in the same memory, or loaded into the same memory at the same time. In some examples, access to portions of representation learning system 780 is limited to different, mutually exclusive sets of user systems and/or servers. In some examples, a separate, personalized version of representation learning system 780 is created for each user of the representation learning system 780 such that data is not shared between or among the separate, personalized versions of the representation learning system 780. In some examples, certain portions of representation learning system 780 are implemented on user systems while other portions of representation learning system 780 are implemented on a server computer or group of servers. In some examples, one or more portions of representation learning system 780 are implemented on user systems. For example, representation learning system 780 is entirely implemented on user systems, e.g., client devices, in some examples. In some examples, a version of representation learning system 780 is embedded in a client device's operating system or stored at the client device and loaded into memory at execution time.

The examples shown in FIG. 7 and the accompanying description, above are provided for illustration purposes. This disclosure is not limited to the described examples.

FIG. 8 is a block diagram of an example computer system including components of a representation learning system in accordance with some examples of the present disclosure.

In FIG. 8, an example machine of a computer system 800 is shown, within which a set of instructions for causing the machine to perform any of the aspects described are executed. In some examples, the computer system 800 corresponds to a component of a networked computer system (e.g., any one or more of the components shown in FIG. 1, FIG. 2, FIG. 3, FIG. 5, FIG. 7) that includes, is coupled to, or utilizes a machine to execute an operating system to perform operations corresponding to any one or more components shown in FIG. 1, FIG. 2, FIG. 3, FIG. 5 FIG. 7. For example, computer system 800 corresponds to a portion of a computing system when the computing system is executing a portion of any one or more components shown in FIG. 1, FIG. 2, FIG. 3, FIG. 5 FIG. 7.

In some examples, the machine is connected (e.g., networked) to other machines in a network, such as a local area network (LAN), an intranet, an extranet, and/or the Internet. In some examples, the machine operates in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a memory 803 (e.g., flash memory, static random access memory (SRAM), etc.), an input/output system 810, and a data storage system 840, which communicate with each other via a bus 830.

Processing device 802 represents at least one general-purpose processing device such as a microprocessor, a central processing unit, or the like. In some examples, the processing device includes a complex instruction set computing (CISC) microprocessor, reduced instruction set computing (RISC) microprocessor, very long instruction word (VLIW) microprocessor, or a processor implementing other instruction sets, or processors implementing a combination of instruction sets. In some examples, processing device 802 includes at least one special-purpose processing device such as an application specific integrated circuit (ASIC), a field programmable gate array (FPGA), a digital signal processor (DSP), network processor, or the like. The processing device 802 is configured to execute instructions 812 for performing the operations and steps discussed herein.

In some examples of FIG. 8, representation learning system 850 represents portions of representation learning system 780 while the computer system 800 is executing those portions of representation learning system 780. Instructions 812 include portions of representation learning system 850 when those portions of the representation learning system 850 are being executed by processing device 802. Thus, the representation learning system 850 is shown in dashed lines as part of instructions 812 to illustrate that, at times, portions of the representation learning system 850 are executed by processing device 802. In some examples, when at least some portion of the representation learning system 850 is embodied in instructions to cause processing device 802 to perform the methods described herein, some of those instructions are read into processing device 802 (e.g., into an internal cache or other memory) from main memory 804 and/or data storage system 840. However, it is not required that all of the representation learning system 850 be included in instructions 812 at the same time and portions of the representation learning system 850 are stored in at least one other component of computer system 800 at other times, e.g., when at least one portion of the representation learning system 850 are not being executed by processing device 802.

The computer system 800 further includes a network interface device 808 to communicate over the network 820. Network interface device 808 provides a two-way data communication coupling to a network. In some examples, network interface device 808 includes an integrated-services digital network (ISDN) card, cable modem, satellite modem, or a modem to provide a data communication connection to a corresponding type of telephone line. In some examples, network interface device 808 includes a local area network (LAN) card to provide a data communication connection to a compatible LAN. In some examples, wireless links are implemented. In some examples, network interface device 808 sends and receives electrical, electromagnetic, or optical signals that carry digital data streams representing various types of information.

In some examples, the network link provides data communication through at least one network to other data devices. In some examples, a network link provides a connection to the world-wide packet data communication network commonly referred to as the “Internet,” e.g., through a local network to a host computer or to data equipment operated by an Internet Service Provider (ISP). Local networks and the Internet use electrical, electromagnetic, or optical signals that carry digital data to and from computer system 800.

Computer system 800 is capable of sending messages and receiving data, including program code, through the network(s) and network interface device 808. In some examples, a server transmits a requested code for an application program through the Internet and network interface device 808. In some examples, the received code is executed by processing device 802 as it is received, and/or stored in data storage system 840 or other non-volatile storage for later execution.

The input/output system 810 includes an output device, such as a display, for example a liquid crystal display (LCD) or a touchscreen display, for displaying information to a computer user, or a speaker, a haptic device, or another form of output device. In some examples, the input/output system 810 includes an input device such as alphanumeric keys and other keys configured for communicating information and command selections to processing device 802. Alternatively or in addition, an input device includes a cursor control, such as a mouse, a trackball, or cursor direction keys for communicating direction information and command selections to processing device 802 and for controlling cursor movement on a display. Alternatively or in addition, an input device includes a microphone, a sensor, or an array of sensors to communicate sensed information to processing device 802. Sensed information includes, for example, voice commands, audio signals, geographic location information, haptic information, and/or digital imagery.

The data storage system 840 includes a machine-readable storage medium 842 (also known as a computer-readable medium) on which is stored at least one set of instructions 844 or software embodying any of the methodologies or functions described herein. In some examples, instructions 844 reside, completely or at least partially, within the main memory 804 and/or within the processing device 802 during execution thereof by the computer system 800, the main memory 804 and the processing device 802 also constituting machine-readable storage media. In some examples, the instructions 844 include instructions to implement functionality corresponding to a representation learning system (e.g., any one or more of the components shown in FIG. 1, FIG. 2, FIG. 3, FIG. 4, FIG. 5, and/or FIG. 7).

Dashed lines are used in FIG. 8 to indicate that it is not required that the representation learning system be embodied entirely in instructions 812, 814, and 844 at the same time. In one example, portions of the representation learning system are embodied in instructions 814, which are read into main memory 804 as instructions 814, and portions of instructions 812 are read into processing device 802 as instructions 812 for execution. In another example, some portions of the representation learning system are embodied in instructions 844 while other portions are embodied in instructions 814 and still other portions are embodied in instructions 812.

While the machine-readable storage medium 842 is shown in an example to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media.

The examples shown in FIG. 8 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure refers to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also or alternatively relates to an apparatus for performing the operations described. In some examples, the apparatus is specially constructed or includes a general-purpose computer selectively activated or reconfigured by a computer program stored in the computer. In some examples, a computer system or other data processing system, including any one or more of the components shown in FIG. 1, FIG. 2, FIG. 3, FIG. 4, FIG. 5, FIG. 7, and/or FIG. 8, carries out the above-described computer-implemented methods in response to a processor executing a computer program (e.g., a sequence of instructions) contained in a memory or other non-transitory machine-readable storage medium. In some examples, the computer program is stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions and which is couplable to a computer or computer bus.

The algorithms and displays presented herein are not inherently related to any particular computer. In addition, the present disclosure is not described with reference to any particular programming language. A variety of programming languages are usable to implement aspects of this disclosure.

In some examples, aspects of this disclosure are provided as a computer program product, or software, which includes a machine-readable medium having instructions stored thereon, where the instructions are used to program a computer system (or other electronic devices) to perform processes as described. A machine-readable medium includes any mechanism for storing information in a form readable by a machine (e.g., a computer). In some examples, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In some examples, techniques described are implemented with privacy safeguards to protect user privacy. In some examples, the techniques described are implemented with user privacy safeguards to prevent unauthorized access to personal data and confidential data. The training of the AI models described herein is executed to benefit all users fairly, without causing or amplifying unfair bias.

According to some examples, the techniques for the models described herein do not make inferences or predictions about individuals unless requested to do so through an input. According to some examples, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities.

According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some examples, users may provide feedback while using the techniques described herein, which may be used to improve or modify the platform and products. In some examples, any personal data associated with a user, such as personal information provided by the user to the platform, may be deleted from storage upon user request. In some examples, personal information associated with a user may be permanently deleted from storage when a user deletes their account from the platform.

According to the techniques described herein, personal data may be removed from any training dataset that is used to train AI models. The techniques described herein may utilize tools for anonymizing user and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some examples, tools are used with the techniques described herein to identify and mitigate risks associated with AI in all products and AI systems. In some examples, notices may be provided to users when AI tools are being used to provide features.

Illustrative examples of the technologies disclosed herein are provided below. An example of the technologies may include any of the examples described herein, or any combination of any of the examples described herein, or any combination of any portions of the examples described herein.

In some aspects, the techniques described herein relate to a method including: converting a log of activities to a natural language representation of the activities in the log, wherein an activity includes first digital content presented to a user via a software application and a signal received by the software application from the user via a device; formulating model input for a language model having a first encoder tower, a second encoder tower, a fusion sub-model, and a context window, wherein the model input includes the natural language representation of the activities and second digital content; providing the natural language representation of the activities to an input layer of the first encoder tower of the language model via the context window; providing the second digital content to an input layer of the second encoder tower of the language model; producing, by an output layer of the first encoder tower, a machine learning-based representation of the activities; producing, by an output layer of the second encoder tower, a machine learning-based representation of the second digital content; providing the machine learning-based representation of the activities and the machine learning-based representation of the second digital content to the fusion sub-model; and producing, by the fusion sub-model, a predicted outcome using the machine learning-based representation of the activities and the machine learning-based representation of the second digital content, wherein the predicted outcome includes a likelihood of the user interacting with the second digital content.

In some aspects, the techniques described herein relate to a method, wherein converting the log of activities to the natural language representation of the activities in the log includes: determining an activity type using the signal and the software application; selecting a template using the activity type; and applying the selected template to the log of activities to produce the natural language representation of the activities in the log.

In some aspects, the techniques described herein relate to a method, wherein formulating model input for a language model includes: including the natural language representation of the activities in a first prompt, wherein the first prompt includes a first instruction to cause the language model to extract activity features from the natural language representation of the activities; and including the second digital content in a second prompt, wherein the second prompt includes a second instruction to cause the language model to extract content features from the second digital content.

In some aspects, the techniques described herein relate to a method, further including: determining a content type of the second digital content; and formulating the second instruction to identify, to the language model, features associated with the content type of the second digital content.

In some aspects, the techniques described herein relate to a method, further including: formulating the language model to include up to one encoder tower for each type of input in the model input.

In some aspects, the techniques described herein relate to a method, further including: training the language model to optimize the machine learning-based representations for multiple different types of predicted outcomes.

In some aspects, the techniques described herein relate to a method, further including: via the fusion sub-model, connecting the machine learning-based representation of the activities with a machine learning-based representation of the first digital content.

In some aspects, the techniques described herein relate to a method, further including: storing the machine learning-based representation of the activities and the machine learning-based representation of the second digital content in computer memory.

In some aspects, the techniques described herein relate to a method, further including, during an inference phase: retrieving the machine learning-based representation of the activities and the machine learning-based representation of the second digital content from the computer memory; providing the retrieved machine learning-based representation of the activities and the machine learning-based representation of the second digital content to the fusion sub-model; and providing the predicted outcome to the software application via the fusion sub-model.

In some aspects, the techniques described herein relate to a method, further including: determining a prediction type of the predicted outcome; using the prediction type to determine whether to include third digital content in the model input or exclude the third digital content from the model input, wherein the third digital content includes content provided by the user via the software application; producing, by a third encoder tower of the language model, a machine learning-based representation of the third digital content; and by the fusion sub-model, using the machine learning-based representation of the third digital content to generate the predicted outcome in accordance with the prediction type.

In some aspects, the techniques described herein relate to a method, further including: during a training phase, backpropagating a loss to weights of the first encoder tower and weights of the second encoder tower to produce a trained language model, wherein the loss estimates change in a difference between the predicted outcome and an actual outcome involving the second digital content.

In some aspects, the techniques described herein relate to a system including: a processor; and a memory, wherein the memory includes instructions that when executed by the processor cause the processor to: convert a log of activities to a natural language representation of the activities in the log, wherein an activity includes first digital content presented to a user via a software application and a signal received by the software application from the user via a device; formulate model input for a language model having a first encoder tower, a second encoder tower, a fusion sub-model, and a context window, wherein the model input includes the natural language representation of the activities and second digital content; provide the natural language representation of the activities to an input layer of the first encoder tower of the language model via the context window; provide the second digital content to an input layer of the second encoder tower of the language model; produce, by an output layer of the first encoder tower, a machine learning-based representation of the activities; produce, by an output layer of the second encoder tower, a machine learning-based representation of the second digital content; provide the machine learning-based representation of the activities and the machine learning-based representation of the second digital content to the fusion sub-model; and produce, by the fusion sub-model, a predicted outcome using the machine learning-based representation of the activities and the machine learning-based representation of the second digital content, wherein the predicted outcome includes a likelihood of the user interacting with the second digital content.

In some aspects, the techniques described herein relate to a system, wherein formulating model input for a language model includes: including the natural language representation of the activities in a first prompt, wherein the first prompt includes a first instruction to cause the language model to extract activity features from the natural language representation of the activities; determining a content type of the second digital content; including the second digital content in a second prompt, wherein the second prompt includes a second instruction to cause the language model to extract content features from the second digital content, wherein the second instruction is formulated to identify, to the language model, features associated with the content type of the second digital content.

In some aspects, the techniques described herein relate to a system, wherein the instructions when executed by the processor further cause the processor to: formulate the language model to include up to one encoder tower for each type of input in the model input.

In some aspects, the techniques described herein relate to a system, wherein the instructions when executed by the processor further cause the processor to: train the language model to optimize the machine learning-based representations for multiple different types of predicted outcomes.

In some aspects, the techniques described herein relate to a system, wherein the instructions when executed by the processor further cause the processor to: via the fusion sub-model, connect the machine learning-based representation of the activities with a machine learning-based representation of the first digital content.

In some aspects, the techniques described herein relate to a non-transitory computer readable medium including instructions that when executed by a processor cause the processor to: convert a log of activities to a natural language representation of the activities in the log, wherein an activity includes first digital content presented to a user via a software application and a signal received by the software application from the user via a device; formulate model input for a language model having a first encoder tower, a second encoder tower, a fusion sub-model, and a context window, wherein the model input includes the natural language representation of the activities and second digital content; provide the natural language representation of the activities to an input layer of the first encoder tower of the language model via the context window; provide the second digital content to an input layer of the second encoder tower of the language model; produce, by an output layer of the first encoder tower, a machine learning-based representation of the activities; produce, by an output layer of the second encoder tower, a machine learning-based representation of the second digital content; provide the machine learning-based representation of the activities and the machine learning-based representation of the second digital content to the fusion sub-model; and produce, by the fusion sub-model, a predicted outcome using the machine learning-based representation of the activities and the machine learning-based representation of the second digital content, wherein the predicted outcome includes a likelihood of the user interacting with the second digital content.

In some aspects, the techniques described herein relate to a non-transitory computer readable medium, wherein the instructions when executed by the processor further cause the processor to: store the machine learning-based representation of the activities and the machine learning-based representation of the second digital content in computer memory; and during an inference phase, retrieve the machine learning-based representation of the activities and the machine learning-based representation of the second digital content from the computer memory; providing the retrieved machine learning-based representation of the activities and the machine learning-based representation of the second digital content to the fusion sub-model; and providing the predicted outcome to the software application via the fusion sub-model.

In some aspects, the techniques described herein relate to a non-transitory computer readable medium, wherein the instructions when executed by the processor further cause the processor to: determine a prediction type of the predicted outcome; use the prediction type to determine whether to include third digital content in the model input or exclude the third digital content from the model input, wherein the third digital content includes content provided by the user via the software application; produce, by a third encoder tower of the language model, a machine learning-based representation of the third digital content; and by the fusion sub-model, use the machine learning-based representation of the third digital content to generate the predicted outcome in accordance with the prediction type.

In some aspects, the techniques described herein relate to a non-transitory computer readable medium, wherein the instructions when executed by the processor further cause the processor to: during a training phase, backpropagate a loss to weights of the first encoder tower and weights of the second encoder tower to produce a trained language model, wherein the loss estimates change in a difference between the predicted outcome and an actual outcome involving the second digital content.

Clause 1. A method comprising: converting a log of activities to a natural language representation of the activities in the log, wherein an activity comprises first digital content presented to a user via a software application and a signal received by the software application from the user via a device; formulating model input for a language model having a first encoder tower, a second encoder tower, a fusion sub-model, and a context window, wherein the model input comprises the natural language representation of the activities and second digital content; providing the natural language representation of the activities to an input layer of the first encoder tower of the language model via the context window; providing the second digital content to an input layer of the second encoder tower of the language model; producing, by an output layer of the first encoder tower, a machine learning-based representation of the activities; producing, by an output layer of the second encoder tower, a machine learning-based representation of the second digital content; providing the machine learning-based representation of the activities and the machine learning-based representation of the second digital content to the fusion sub-model; and producing, by the fusion sub-model, a predicted outcome using the machine learning-based representation of the activities and the machine learning-based representation of the second digital content, wherein the predicted outcome comprises a likelihood of the user interacting with the second digital content.

Clause 2. The method of clause 1, wherein converting the log of activities to the natural language representation of the activities in the log comprises: determining an activity type using the signal and the software application; selecting a template using the activity type; and applying the selected template to the log of activities to produce the natural language representation of the activities in the log.

Clause 3. The method of clause 1 or clause 2, wherein formulating model input for a language model comprises: including the natural language representation of the activities in a first prompt, wherein the first prompt comprises a first instruction to cause the language model to extract activity features from the natural language representation of the activities; and including the second digital content in a second prompt, wherein the second prompt comprises a second instruction to cause the language model to extract content features from the second digital content.

Clause 4. The method of clause 3, further comprising: determining a content type of the second digital content; and formulating the second instruction to identify, to the language model, features associated with the content type of the second digital content.

Clause 5. The method of any of clauses 1-4, further comprising: formulating the language model to include up to one encoder tower for each type of input in the model input.

Clause 6. The method of any of clauses 1-5, further comprising: training the language model to optimize the machine learning-based representations for multiple different types of predicted outcomes.

Clause 7. The method of any of clauses 1-6, further comprising: via the fusion sub-model, connecting the machine learning-based representation of the activities with a machine learning-based representation of the first digital content.

Clause 8. The method of any of clauses 1-8, further comprising: storing the machine learning-based representation of the activities and the machine learning-based representation of the second digital content in computer memory.

Clause 9. The method of clause 8, further comprising, during an inference phase: retrieving the machine learning-based representation of the activities and the machine learning-based representation of the second digital content from the computer memory; providing the retrieved machine learning-based representation of the activities and the machine learning-based representation of the second digital content to the fusion sub-model; and providing the predicted outcome to the software application via the fusion sub-model.

Clause 10. The method of any of clauses 1-9, further comprising: determining a prediction type of the predicted outcome; using the prediction type to determine whether to include third digital content in the model input or exclude the third digital content from the model input, wherein the third digital content comprises content provided by the user via the software application; producing, by a third encoder tower of the language model, a machine learning-based representation of the third digital content; and by the fusion sub-model, using the machine learning-based representation of the third digital content to generate the predicted outcome in accordance with the prediction type.

Clause 11. The method of any of clauses 1-10, further comprising: during a training phase, backpropagating a loss to weights of the first encoder tower and weights of the second encoder tower to produce a trained language model, wherein the loss estimates change in a difference between the predicted outcome and an actual outcome involving the second digital content.

Clause 12. A system comprising: a processor; and a memory, wherein the memory comprises instructions that when executed by the processor cause the processor to: convert a log of activities to a natural language representation of the activities in the log, wherein an activity comprises first digital content presented to a user via a software application and a signal received by the software application from the user via a device; formulate model input for a language model having a first encoder tower, a second encoder tower, a fusion sub-model, and a context window, wherein the model input comprises the natural language representation of the activities and second digital content; provide the natural language representation of the activities to an input layer of the first encoder tower of the language model via the context window; provide the second digital content to an input layer of the second encoder tower of the language model; produce, by an output layer of the first encoder tower, a machine learning-based representation of the activities; produce, by an output layer of the second encoder tower, a machine learning-based representation of the second digital content; provide the machine learning-based representation of the activities and the machine learning-based representation of the second digital content to the fusion sub-model; and produce, by the fusion sub-model, a predicted outcome using the machine learning-based representation of the activities and the machine learning-based representation of the second digital content, wherein the predicted outcome comprises a likelihood of the user interacting with the second digital content.

Clause 13. The system of clause 12, wherein formulating model input for a language model comprises: including the natural language representation of the activities in a first prompt, wherein the first prompt comprises a first instruction to cause the language model to extract activity features from the natural language representation of the activities; determining a content type of the second digital content; including the second digital content in a second prompt, wherein the second prompt comprises a second instruction to cause the language model to extract content features from the second digital content, wherein the second instruction is formulated to identify, to the language model, features associated with the content type of the second digital content.

Clause 14. The system of clause 12 or clause 13, wherein the instructions when executed by the processor further cause the processor to: formulate the language model to include up to one encoder tower for each type of input in the model input.

Clause 15. The system of any of clauses 12-14, wherein the instructions when executed by the processor further cause the processor to: train the language model to optimize the machine learning-based representations for multiple different types of predicted outcomes.

Clause 16. The system of any of clauses 12-15, wherein the instructions when executed by the processor further cause the processor to: via the fusion sub-model, connect the machine learning-based representation of the activities with a machine learning-based representation of the first digital content.

Clause 17. A non-transitory computer readable medium comprising instructions that when executed by a processor cause the processor to: convert a log of activities to a natural language representation of the activities in the log, wherein an activity comprises first digital content presented to a user via a software application and a signal received by the software application from the user via a device; formulate model input for a language model having a first encoder tower, a second encoder tower, a fusion sub-model, and a context window, wherein the model input comprises the natural language representation of the activities and second digital content; provide the natural language representation of the activities to an input layer of the first encoder tower of the language model via the context window; provide the second digital content to an input layer of the second encoder tower of the language model; produce, by an output layer of the first encoder tower, a machine learning-based representation of the activities; produce, by an output layer of the second encoder tower, a machine learning-based representation of the second digital content; provide the machine learning-based representation of the activities and the machine learning-based representation of the second digital content to the fusion sub-model; and produce, by the fusion sub-model, a predicted outcome using the machine learning-based representation of the activities and the machine learning-based representation of the second digital content, wherein the predicted outcome comprises a likelihood of the user interacting with the second digital content.

Clause 18. The non-transitory computer readable medium of clause 17, wherein the instructions when executed by the processor further cause the processor to: store the machine learning-based representation of the activities and the machine learning-based representation of the second digital content in computer memory; and during an inference phase, retrieve the machine learning-based representation of the activities and the machine learning-based representation of the second digital content from the computer memory; providing the retrieved machine learning-based representation of the activities and the machine learning-based representation of the second digital content to the fusion sub-model; and providing the predicted outcome to the software application via the fusion sub-model.

Clause 19. The non-transitory computer readable medium of clause 17 or clause 18, wherein the instructions when executed by the processor further cause the processor to: determine a prediction type of the predicted outcome; use the prediction type to determine whether to include third digital content in the model input or exclude the third digital content from the model input, wherein the third digital content comprises content provided by the user via the software application; produce, by a third encoder tower of the language model, a machine learning-based representation of the third digital content; and by the fusion sub-model, use the machine learning-based representation of the third digital content to generate the predicted outcome in accordance with the prediction type.

Clause 20. The non-transitory computer readable medium of any of clauses 17-19, wherein the instructions when executed by the processor further cause the processor to: during a training phase, backpropagate a loss to weights of the first encoder tower and weights of the second encoder tower to produce a trained language model, wherein the loss estimates change in a difference between the predicted outcome and an actual outcome involving the second digital content.

Examples of the disclosure have been described with reference to specific examples. The described examples are modifiable without departing from the broader spirit and scope of the disclosure as set forth in the claims. The specification and drawings are to be regarded in an illustrative sense rather than a restrictive sense.

What is claimed is:

1. A method comprising:
converting a log of activities to a natural language representation of the activities in the log, wherein an activity comprises first digital content presented to a user via a software application and a signal received by the software application from the user via a device;
formulating model input for a language model having a first encoder tower, a second encoder tower, a fusion sub-model, and a context window, wherein the model input comprises the natural language representation of the activities and second digital content;
providing the natural language representation of the activities to an input layer of the first encoder tower of the language model via the context window;
providing the second digital content to an input layer of the second encoder tower of the language model;
producing, by an output layer of the first encoder tower, a machine learning-based representation of the activities;
producing, by an output layer of the second encoder tower, a machine learning-based representation of the second digital content;
providing the machine learning-based representation of the activities and the machine learning-based representation of the second digital content to the fusion sub-model; and
producing, by the fusion sub-model, a predicted outcome using the machine learning-based representation of the activities and the machine learning-based representation of the second digital content, wherein the predicted outcome comprises a likelihood of the user interacting with the second digital content.

2. The method of claim 1, wherein converting the log of activities to the natural language representation of the activities in the log comprises:
determining an activity type using the signal and the software application;
selecting a template using the activity type; and
applying the selected template to the log of activities to produce the natural language representation of the activities in the log.

3. The method of claim 1, wherein formulating model input for a language model comprises:
including the natural language representation of the activities in a first prompt, wherein the first prompt comprises a first instruction to cause the language model to extract activity features from the natural language representation of the activities; and
including the second digital content in a second prompt, wherein the second prompt comprises a second instruction to cause the language model to extract content features from the second digital content.

4. The method of claim 3, further comprising:
determining a content type of the second digital content; and
formulating the second instruction to identify, to the language model, features associated with the content type of the second digital content.

5. The method of claim 1, further comprising:
formulating the language model to include up to one encoder tower for each type of input in the model input.

6. The method of claim 1, further comprising:
training the language model to optimize the machine learning-based representations for multiple different types of predicted outcomes.

7. The method of claim 1, further comprising:
via the fusion sub-model, connecting the machine learning-based representation of the activities with a machine learning-based representation of the first digital content.

8. The method of claim 1, further comprising:
storing the machine learning-based representation of the activities and the machine learning-based representation of the second digital content in computer memory.

9. The method of claim 8, further comprising, during an inference phase:
retrieving the machine learning-based representation of the activities and the machine learning-based representation of the second digital content from the computer memory;
providing the retrieved machine learning-based representation of the activities and the machine learning-based representation of the second digital content to the fusion sub-model; and
providing the predicted outcome to the software application via the fusion sub-model.

10. The method of claim 1, further comprising:
determining a prediction type of the predicted outcome;
using the prediction type to determine whether to include third digital content in the model input or exclude the third digital content from the model input, wherein the third digital content comprises content provided by the user via the software application;
producing, by a third encoder tower of the language model, a machine learning-based representation of the third digital content; and
by the fusion sub-model, using the machine learning-based representation of the third digital content to generate the predicted outcome in accordance with the prediction type.

11. The method of claim 1, further comprising:
during a training phase, backpropagating a loss to weights of the first encoder tower and weights of the second encoder tower to produce a trained language model, wherein the loss estimates change in a difference between the predicted outcome and an actual outcome involving the second digital content.

12. A system comprising:
a processor; and
a memory, wherein the memory comprises instructions that when executed by the processor cause the processor to:
convert a log of activities to a natural language representation of the activities in the log, wherein an activity comprises first digital content presented to a user via a software application and a signal received by the software application from the user via a device;
formulate model input for a language model having a first encoder tower, a second encoder tower, a fusion sub-model, and a context window, wherein the model input comprises the natural language representation of the activities and second digital content;
provide the natural language representation of the activities to an input layer of the first encoder tower of the language model via the context window;
provide the second digital content to an input layer of the second encoder tower of the language model;
produce, by an output layer of the first encoder tower, a machine learning-based representation of the activities;
produce, by an output layer of the second encoder tower, a machine learning-based representation of the second digital content;
provide the machine learning-based representation of the activities and the machine learning-based representation of the second digital content to the fusion sub-model; and
produce, by the fusion sub-model, a predicted outcome using the machine learning-based representation of the activities and the machine learning-based representation of the second digital content, wherein the predicted outcome comprises a likelihood of the user interacting with the second digital content.

13. The system of claim 12, wherein formulating model input for a language model comprises:
including the natural language representation of the activities in a first prompt, wherein the first prompt comprises a first instruction to cause the language model to extract activity features from the natural language representation of the activities;
determining a content type of the second digital content;
including the second digital content in a second prompt, wherein the second prompt comprises a second instruction to cause the language model to extract content features from the second digital content, wherein the second instruction is formulated to identify, to the language model, features associated with the content type of the second digital content.

14. The system of claim 12, wherein the instructions when executed by the processor further cause the processor to:
formulate the language model to include up to one encoder tower for each type of input in the model input.

15. The system of claim 12, wherein the instructions when executed by the processor further cause the processor to:
train the language model to optimize the machine learning-based representations for multiple different types of predicted outcomes.

16. The system of claim 12, wherein the instructions when executed by the processor further cause the processor to:
via the fusion sub-model, connect the machine learning-based representation of the activities with a machine learning-based representation of the first digital content.

17. A non-transitory computer readable medium comprising instructions that when executed by a processor cause the processor to:
convert a log of activities to a natural language representation of the activities in the log, wherein an activity comprises first digital content presented to a user via a software application and a signal received by the software application from the user via a device;
formulate model input for a language model having a first encoder tower, a second encoder tower, a fusion sub-model, and a context window, wherein the model input comprises the natural language representation of the activities and second digital content;
provide the natural language representation of the activities to an input layer of the first encoder tower of the language model via the context window;
provide the second digital content to an input layer of the second encoder tower of the language model;
produce, by an output layer of the first encoder tower, a machine learning-based representation of the activities;
produce, by an output layer of the second encoder tower, a machine learning-based representation of the second digital content;
provide the machine learning-based representation of the activities and the machine learning-based representation of the second digital content to the fusion sub-model; and
produce, by the fusion sub-model, a predicted outcome using the machine learning-based representation of the activities and the machine learning-based representation of the second digital content, wherein the predicted outcome comprises a likelihood of the user interacting with the second digital content.

18. The non-transitory computer readable medium of claim 17, wherein the instructions when executed by the processor further cause the processor to:
store the machine learning-based representation of the activities and the machine learning-based representation of the second digital content in computer memory; and
during an inference phase, retrieve the machine learning-based representation of the activities and the machine learning-based representation of the second digital content from the computer memory; providing the retrieved machine learning-based representation of the activities and the machine learning-based representation of the second digital content to the fusion sub-model; and providing the predicted outcome to the software application via the fusion sub-model.

19. The non-transitory computer readable medium of claim 17, wherein the instructions when executed by the processor further cause the processor to:
determine a prediction type of the predicted outcome;
use the prediction type to determine whether to include third digital content in the model input or exclude the third digital content from the model input, wherein the third digital content comprises content provided by the user via the software application;
produce, by a third encoder tower of the language model, a machine learning-based representation of the third digital content; and
by the fusion sub-model, use the machine learning-based representation of the third digital content to generate the predicted outcome in accordance with the prediction type.

20. The non-transitory computer readable medium of claim 17, wherein the instructions when executed by the processor further cause the processor to:
during a training phase, backpropagate a loss to weights of the first encoder tower and weights of the second encoder tower to produce a trained language model, wherein the loss estimates change in a difference between the predicted outcome and an actual outcome involving the second digital content.
